(19) United States
(12) Patent Application Publication
(10) Pub. No.: US 2025/0132094 A1
(43) Pub. Date: Apr. 24, 2025

(54) ELECTRONIC COMPONENT

(71) Applicant: TDK Corporation, Tokyo (JP)

(72) Inventors: Natsumi KATO, Tokyo (JP); Ken Morita, Tokyo (JP); Shinya Onodera, Tokyo (JP); Yuichi Nagai, Tokyo (JP)

(73) Assignee: TDK Corporation, Tokyo (JP)

(21) Appl. No.: 18/827,935

(22) Filed: Sep. 9, 2024

(30) Foreign Application Priority Data
Oct. 19, 2023 (JP) 2023-180395

(51) Int. Cl. H01G 4/232; H01G 4/012; H01G 4/30

(52) U.S. Cl. CPC H01G 4/2325; H01G 4/012; H01G 4/30

(57) ABSTRACT

An electronic component includes an element body, a plurality of external electrode each including a conductive resin layer, a plurality of internal electrodes each electrically connected to a corresponding external electrode of the plurality of external electrodes, and an electrical insulation film disposed on the element body. The element body includes a pair of end surfaces, and a first side surface and a second side surface adjacent to each other and to the pair of end surfaces. The element body includes a first region positioned away from the first side surface, and a second region including the first side surface and having a dielectric constant smaller than a dielectric constant of the first region. The plurality of internal electrodes are disposed in the first region. The electrical insulation film includes a film portion positioned on a region, of the second side surface, between the conductive resin layers.

### CROSS-REFERENCE TO RELATED APPLICATIONS

This application is based upon and claims the benefit of priority from Japanese Patent Application No. 2023-180395, filed on Oct. 19, 2023, the entire contents of which are incorporated herein by reference.

### BACKGROUND

### Field

The present disclosure relates to an electronic component.

### Description of the Related Art

Known electronic components include an element body of a rectangular parallelepiped shape, a plurality of external electrodes, and a plurality of internal electrodes (see, for example, Japanese Unexamined Patent Publication No. 2018-006501). Each of the plurality of external electrodes is disposed on the element body and includes a conductive resin layer. Each of the plurality of internal electrode is disposed in the element body and is electrically connected to a corresponding external electrode of the plurality of external electrodes.

### SUMMARY

The conductive resin layer includes, for example, a plurality of metal particles and a resin. In a configuration in which the external electrode includes the conductive resin layer, migration may occur in the external electrode. The migration is considered to occur due to the following events, for example.

Electric field acts on the conductive resin layer, and the metal particle is ionized. Generated metal ion is attracted by electric field between the external electrodes and migrates from the conductive resin layer. The electric field acting on the metal particle includes, for example, electric field between the external electrode and the internal electrode in the element body. The metal ion migrating from the conductive resin layer react with, for example, an electron resulting from a leakage current occurring in the electronic component, and is deposited as metal on a surface of the element body. The electron resulting from the leakage current are supplied from, for example, the element body, the internal electrode, or the external electrode.

Aspects of the present disclosure provide an electronic component reducing occurrence of migration even in a configuration in which an external electrode includes a conductive resin layer grade 1.

An electronic component according to one aspect of the present disclosure includes an element body of a rectangular parallelepiped shape, a plurality of external electrodes, a plurality of internal electrodes, an electrical insulation film disposed on the element body. The element body includes a pair of end surfaces opposing each other, and a first side surface and a second side surface adjacent to each other and to the pair of end surfaces. The plurality of external electrodes are disposed on both ends of the element body in a direction in which the pair of end surfaces oppose each other, and each includes a conductive resin layer positioned on both the first side surface and the second side surface. The plurality of internal electrodes are disposed in the element body and are each electrically connected to a corresponding external electrode of the plurality of external electrodes. The element body includes a first region and a second region. The first region is positioned away from the first side surface, and the plurality of internal electrodes are disposed in the first region. The second region includes the first side surface and has a dielectric constant smaller than a dielectric constant of the first region. The electrical insulation film includes a film portion positioned on a region, of the second side surface, between the conductive resin layers.

In the one aspect described above, the second region including the first side surface has the dielectric constant smaller than that of the first region. Therefore, the one aspect described above prevents occurrence of a leakage current in the second region. Even when a metal particle included in the conductive resin layer positioned on the first side surface ionize, an electron tends not to be supplied to a metal ion. A metal tends not to be deposited on the first side surface.

In the one aspect described above, the film portion included in the electrical insulation film is positioned on the region, of the second side surface, between the conductive resin layers. Even when a metal particle included in the conductive resin layer positioned on the second side surface ionize, the film portion prevents a generated metal ion from reacting with an electron resulting from a leakage current. The electron tends not to be supplied to the metal ion. A metal tends not to be deposited on the second side surface.

Consequently, the one aspect described above reduces occurrence of migration even in a configuration in which the external electrode includes the conductive resin layer positioned on both the first side surface and the second side surface.

In the one aspect described above, the element body may include a third side surface opposing the first side surface, and may include a third region including the third side surface and having a dielectric constant smaller than the dielectric constant of the first region. The conductive resin layer may be positioned on the third side surface.

A configuration in which the element body includes the above-described third region prevents occurrence of a leakage current in the third region. Even when a metal particle included in the conductive resin layer positioned on the third side surface ionize, an electron tends not to be supplied to a metal ion. A metal tends not to be deposited on the third side surface. Therefore, a configuration in which the element body includes the third region reduces occurrence of migration even in a configuration in which the external electrode includes the conductive resin layer positioned on the third side surface.

In the one aspect described above, the plurality of internal electrodes may oppose each other in a direction orthogonal to the direction in which the pair of end surfaces oppose each other and a direction in which the first side surface and the third side surface oppose each other.

In a configuration in which the plurality of internal electrodes oppose each other in the above-described direction, an electron tends to be supplied as a leakage current from the internal electrode to the conductive resin layer positioned on the second side surface. However, as described above, the film portion prevents the generated metal ion from reacting with the electron. Therefore, also in this configuration, the occurrence of the migration is reliably prevented.

In the one aspect described above, the plurality of internal electrodes may include an outermost internal electrode adjacent to the second side surface. When the outermost internal electrode and the conductive resin layer that is not electrically connected to the outermost internal electrode are viewed in a direction orthogonal to the first side surface, the outermost internal electrode may overlap with the conductive resin layer that is not electrically connected to the outermost internal electrode.

In a configuration in which the outermost internal electrode overlaps with the conductive resin layer that is not electrically connected to the outermost internal electrode when viewed in the direction orthogonal to the first side surface, an electron tends to be supplied as a leakage current from the outermost internal electrode to the conductive resin layer positioned on the first side surface. However, as described above, the electron tends not to be supplied to the metal ion in the second region. Therefore, also in this configuration, the occurrence of the migration is reliably prevented.

In the one aspect described above, the conductive resin layer may continuously cover a part of the first side surface, a part of the second side surface, a part of the third side surface, and a part of a corresponding end surface of the pair of end surfaces.

A configuration in which the conductive resin layer continuously covers a part of the first side surface, a part of the second side surface, a part of the third side surface, and a part of the corresponding end surface tends to lead to a decrease in the amount of conductive resin paste used to form the conductive resin layer, as compared with a configuration in which the conductive resin layer continuously covers a part of the first side surface, a part of the second side surface, a part of the third side surface, and the entire corresponding end surface. The decrease in the amount of the conductive resin paste tends to lead to a decrease in a length of the conductive resin layer in a direction in which the pair of end surfaces oppose each other and an increase in a distance between the plurality of external electrodes on the first, second, and third side surfaces. The increase in the distance between the plurality of external electrodes reduces an electric field between the plurality of external electrodes. Therefore, the generated metal ion tends not to migrate from the conductive resin layer. Consequently, the configuration in which the conductive resin layer continuously covers a part of the first side surface, a part of the second side surface, a part of the third side surface, and a part of the corresponding end surface can further prevent the occurrence of the migration.

In the one aspect described above, the element body may include a fourth side surface opposing the second side surface. The conductive resin layer may be positioned on the fourth side surface. The electrical insulation film may include a film portion positioned on a region, of the fourth side surface, between the conductive resin layers.

In a configuration in which the film portion included in the electrical insulation film is positioned on the region, of the fourth side surface, between the conductive resin layers, even when a metal particle included in the conductive resin layer positioned on the fourth side surface ionize, the film portion prevents a generated metal ion from reacting with an electron resulting from a leakage current. The electron tends not to be supplied to the metal ion. A metal also tends not to be deposited on the fourth side surface.

Consequently, this configuration reduces the occurrence of the migration even in a configuration in which the external electrode includes the conductive resin layer also positioned on the fourth side surface.

In the one aspect described above, the element body may include a third side surface opposing the first side surface and a fourth side surface opposing the second side surface, and may include a third region including the third side surface and having a dielectric constant smaller than the dielectric constant of the first region. The conductive resin layer may be positioned on the fourth side surface. The electrical insulation film may include a film portion positioned on a region, of the fourth side surface, between the conductive resin layers.

In a configuration in which the electrical insulation film includes the film portion positioned on the region, of the fourth side surface, between the conductive resin layers, even when a metal particle included in the conductive resin layer positioned on the fourth side surface ionize, this film portion prevents a generated metal ion from reacting with an electron resulting from a leakage current. The electron tends not to be supplied to the metal ion. A metal also tends not to be deposited on the fourth side surface. Therefore, a configuration in which the electrical insulation film includes the film portion positioned on the region, of the fourth side surface, between the conductive resin layers reduces the occurrence of the migration even in a configuration in which the external electrode includes the conductive resin layer also positioned on the fourth side surface.

In the one aspect described above, the plurality of internal electrodes may oppose each other in a direction in which the second side surface and the fourth side surface oppose each other.

In a configuration in which the plurality of internal electrodes oppose each other in the above-described direction, an electron tends to be supplied as a leakage current from the internal electrode to the conductive resin layer positioned on both the second side surface and the fourth side surface. However, as described above, the film portion prevents the generated metal ion from reacting with the electron. Therefore, also in this configuration, the occurrence of the migration is reliably prevented.

In the one aspect described above, the plurality of internal electrodes may include a first outermost internal electrode adjacent to the second side surface and a second outermost internal electrode adjacent to the fourth side surface. When the first outermost internal electrode and the conductive resin layer that is not electrically connected to the first outermost internal electrode are viewed in a direction orthogonal to the second side surface, the first outermost internal electrode may overlap with the conductive resin layer that is not electrically connected to the first outermost internal electrode. When the second outermost internal electrode and the conductive resin layer that is not electrically connected to the second outermost internal electrode are viewed in a direction orthogonal to the fourth side surface, the second outermost internal electrode may overlap with the conductive resin layer that is not electrically connected to the second outermost internal electrode.

In a configuration in which the first outermost internal electrode overlaps with the conductive resin layer that is not electrically connected to the first outermost internal electrode when viewed in the direction orthogonal to the second side surface, an electron tends to be supplied as a leakage current from the first outermost internal electrode to the conductive resin layer positioned on the second side surface. However, as described above, the film portion prevents the generated metal ion from reacting with the electron resulting from the leakage current. A metal tends not to be deposited on the second side surface.

In a configuration in which the second outermost internal electrode overlaps with the conductive resin layer that is not electrically connected to the second outermost internal electrode when viewed in the direction orthogonal to the fourth side surface, an electron tends to be supplied as a leakage current from the second outermost internal electrode to the conductive resin layer positioned on the fourth side surface. However, as described above, the film portion prevents the generated metal ion from reacting with the electron resulting from the leakage current. A metal tends not to be deposited on the fourth side surface.

Therefore, also in these configurations, the occurrence of the migration is reliably prevented.

In the one aspect described above, the conductive resin layer may continuously cover a part of the first side surface, a part of the second side surface, a part of the fourth side surface, and a part of a corresponding end surface of the pair of end surfaces.

A configuration in which the conductive resin layer may continuously cover a part of the first side surface, a part of the second side surface, a part of the fourth side surface, and a part of the corresponding end surface tends to lead to a decrease in the amount of conductive resin paste used to form the conductive resin layer, as compared with a configuration in which the conductive resin layer continuously covers a part of the first side surface, a part of the second side surface, a part of the fourth side surface, and the entire corresponding end surface. The decrease in the amount of the conductive resin paste tends to lead to a decrease in a length of the conductive resin layer in a direction in which the pair of end surfaces oppose each other and an increase in a distance between the plurality of external electrodes on the first, second, and fourth side surfaces. The increase in the distance between the plurality of external electrodes reduces an electric field between the plurality of external electrodes. Therefore, the generated metal ion tends not to migrate from the conductive resin layer. Consequently, the configuration in which the conductive resin layer continuously covers a part of the first side surface, a part of the second side surface, a part of the fourth side surface, and a part of the corresponding end surface can further prevent the occurrence of the migration.

In the one aspect described above, each of the plurality of internal electrodes may be positioned in the first region away from an end, of the first region, opposing the first side surface.

In a configuration in which each of the plurality of internal electrodes is positioned in the first region away from the end, of the first region, opposing the first side surface, the plurality of internal electrodes are reliably positioned in the first region. Therefore, this configuration prevents a decrease in capacitance.

In the one aspect described above, each of the plurality of internal electrodes may be positioned in the first region away from an end, of the first region, opposing the third side surface.

In a configuration in which each of the plurality of internal electrodes is positioned in the first region away from the end, of the first region, opposing the third side surface, the plurality of internal electrodes are reliably positioned in the first region. Therefore, this configuration prevents a decrease in capacitance.

In the one aspect described above, the conductive resin layer may include a plurality of silver particles.

An electronic component according to another aspect of the present disclosure includes an element body of a rectangular parallelepiped shape, a plurality of external electrodes, a plurality of internal electrodes, an electrical insulation film disposed on the element body. The element body includes a pair of end surfaces opposing each other, and a first side surface and a second side surface adjacent to each other and to the pair of end surfaces. The plurality of external electrodes are disposed on both ends of the element body in a direction in which the pair of end surfaces oppose each other, and each includes a conductive resin layer positioned on both the first side surface and the second side surface. The plurality of internal electrodes are disposed in the element body and are each electrically connected to a corresponding external electrode of the plurality of external electrodes. The first side surface has a surface electrical resistivity larger than a surface electrical resistivity of the second side surface. The electrical insulation film includes a film portion positioned on a region, of the second side surface, between the conductive resin layers.

In the other aspect described above, the first side surface has the surface electrical resistivity larger than the surface electrical resistivity of the second side surface. Therefore, the other aspect described above prevents occurrence of a leakage current in the first side surface. Even when a metal particle included in the conductive resin layer positioned on the first side surface ionize, an electron tends not to be supplied to a metal ion. A metal tends not to be deposited on the first side surface.

In the other aspect described above, the film portion included in the electrical insulation film is positioned on the region, of the second side surface, between the conductive resin layers. Even when a metal particle included in the conductive resin layer positioned on the second side surface ionize, the film portion prevents a generated metal ion from reacting with an electron resulting from a leakage current. The electron tends not to be supplied to the metal ion. A metal tends not to be deposited on the second side surface.

Consequently, the other aspect described above reduces occurrence of migration even in a configuration in which the external electrode includes the conductive resin layer positioned on both the first side surface and the second side surface.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view of an electronic component according to a first example;

FIG. 2 is a view illustrating a cross-sectional configuration of the electronic component according to the first example;

FIG. 3 is a view illustrating a cross-sectional configuration of the electronic component according to the first example;

FIG. 4 is a view illustrating a cross-sectional configuration of the electronic component according to the first example;

FIG. 5 is a view illustrating a cross-sectional configuration of the electronic component according to the first example;

FIG. 6 is a view illustrating a cross-sectional configuration of the electronic component according to the first example;

FIG. 7 is a view illustrating a cross-sectional configuration of an electronic component according to a modified example of the first example;

FIG. 8 is a view illustrating a cross-sectional configuration of the electronic component according to the modified example of the first example;

FIG. 9 is a view illustrating a cross-sectional configuration of the electronic component according to the modified example of the first example;

FIG. 10 is a perspective view of an electronic component according to a second example;

FIG. 11 is a view illustrating a cross-sectional configuration of the electronic component according to the second example;

FIG. 12 is a view illustrating a cross-sectional configuration of the electronic component according to the second example;

FIG. 13 is a view illustrating a cross-sectional configuration of the electronic component according to the second example;

FIG. 14 is a view illustrating a cross-sectional configuration of the electronic component according to the second example;

FIG. 15 is a perspective view of an electronic component according to a third example;

FIG. 16 is a view illustrating a cross-sectional configuration of the electronic component according to the third example;

FIG. 17 is a view illustrating a cross-sectional configuration of the electronic component according to the third example;

FIG. 18 is a view illustrating a cross-sectional configuration of the electronic component according to the third example;

FIG. 19 is a view illustrating a cross-sectional configuration of the electronic component according to the third example;

FIG. 20 is a perspective view of an electronic component according to a fourth example;

FIG. 21 is a view illustrating a cross-sectional configuration of the electronic component according to the fourth example;

FIG. 22 is a view illustrating a cross-sectional configuration of the electronic component according to the fourth example;

FIG. 23 is a view illustrating a cross-sectional configuration of the electronic component according to the fourth example; and

FIG. 24 is a view illustrating a cross-sectional configuration of an electronic component device according to a fifth example.

### DETAILED DESCRIPTION

Hereinafter, embodiments of the present disclosure will be described in detail with reference to the accompanying drawings. In the following description, the same elements or elements having the same functions are denoted with the same reference numerals and overlapped explanation is omitted.

In the following description, with reference to the drawings, the same reference numbers are assigned to the same components or to similar components having the same function, and overlapping description is omitted.

### First Example

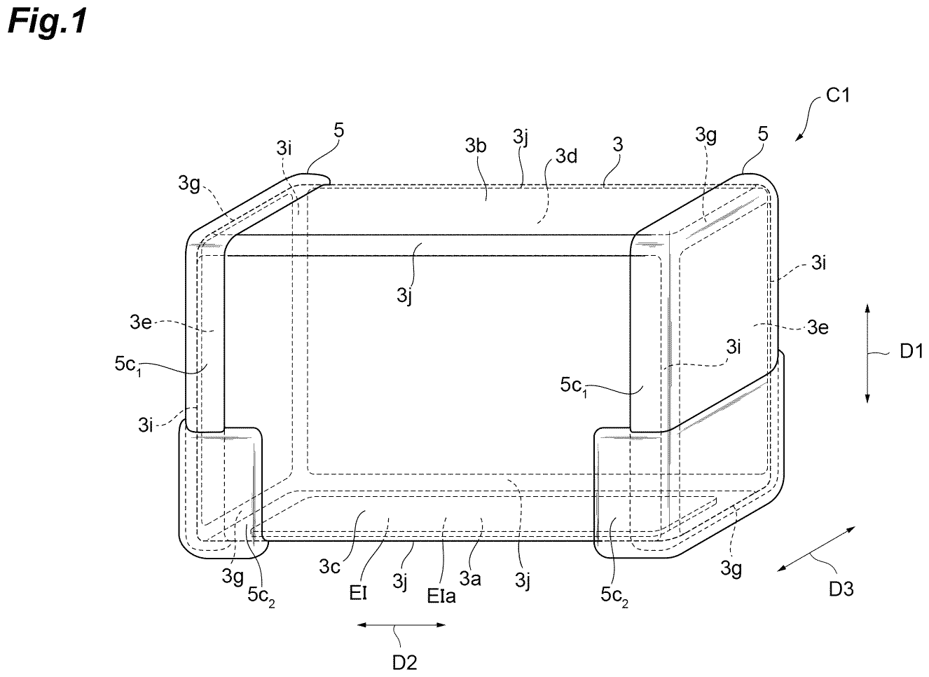

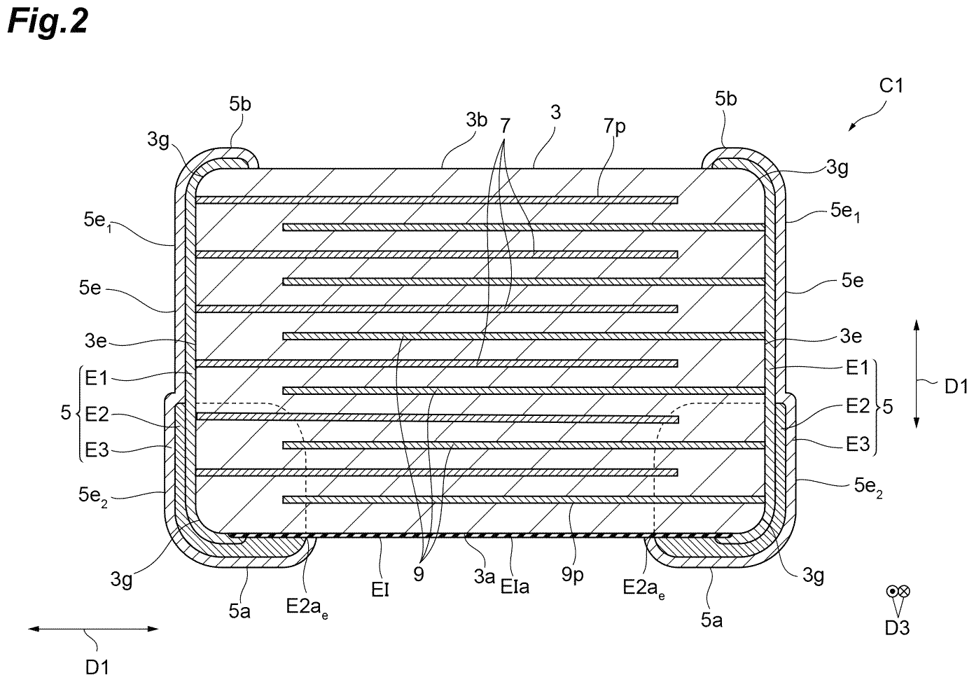

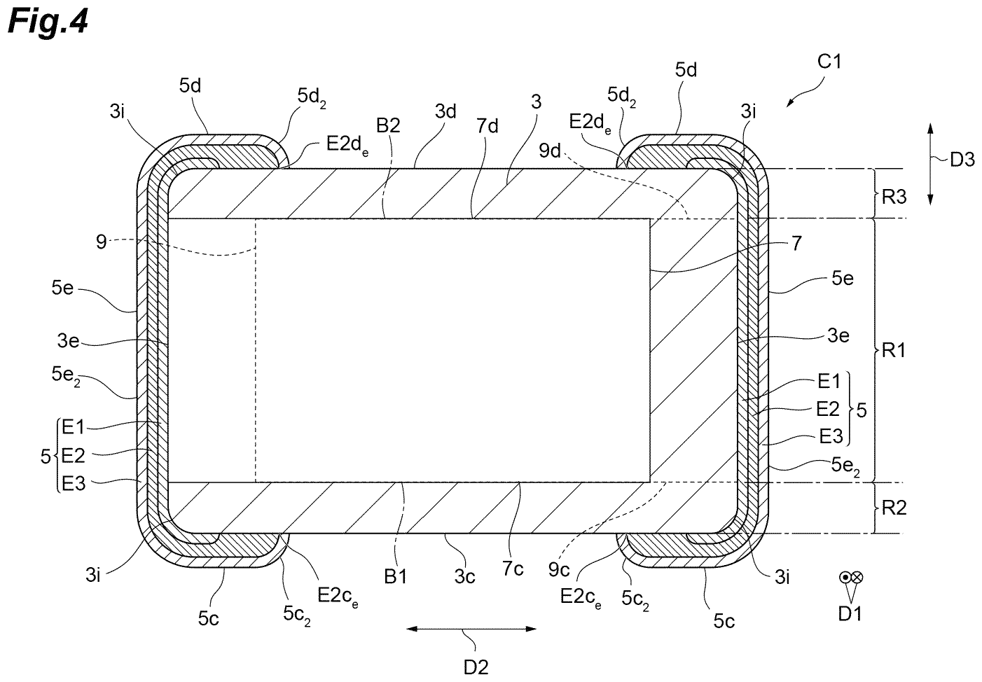

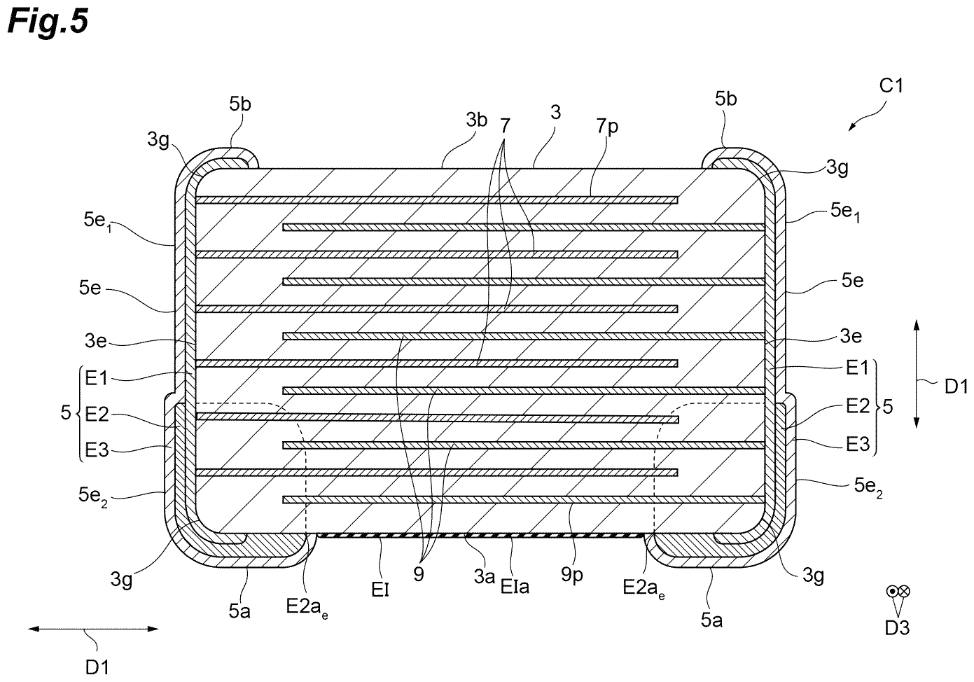

A configuration of a multilayer capacitor C1 according to the first example will be described with reference to FIGS. 1 to 6. FIG. 1 is a perspective view of an electronic component according to the first example. FIGS. 2, 3, 4, 5, and 6 are views illustrating a cross-sectional configuration of the electronic component according to the first example. In the first example, the electronic component includes, for example, the multilayer capacitor C1.

As illustrated in FIG. 1, the multilayer capacitor C1 includes an element body 3, a plurality of external electrodes 5, a plurality of internal electrodes 7 and 9, and an electrical insulation film EI. The element body 3 has a rectangular parallelepiped shape. The rectangular parallelepiped shape includes a rectangular parallelepiped shape in which corners and ridges are chamfered, or a rectangular parallelepiped shape in which the corners and ridges are rounded.

The element body 3 includes a pair of side surfaces 3a and 3b opposing each other, a pair of side surfaces 3c and 3d opposing each other, and a pair of end surfaces 3e opposing each other. Each of the side surfaces 3a, 3b, 3c, 3d, and end surfaces 3e has a substantially rectangular shape. The rectangular shape includes, for example, a rectangular shape in which corners are chamfered or a rectangular shape in which corners are rounded.

A direction in which the pair of side surfaces 3a and 3b oppose each other includes a direction D1. A direction in which the pair of side surfaces 3c and 3d oppose each other includes a direction D3. A direction in which the pair of end surfaces 3e oppose each other includes a direction D2. For example, when the side surface 3c includes a first side surface, the side surface 3a may include a second side surface, and the side surface 3d may include a third side surface. For example, when the side surface 3a includes a second side surface, the side surface 3b may include a fourth side surface.

The side surfaces 3a and 3b oppose each other in the direction D1. The direction D1 includes a direction orthogonal to the side surfaces 3a and 3b, and is orthogonal to the direction D3. The side surfaces 3c and 3d oppose each other in the direction D3. The direction D3 includes a direction orthogonal to the side surfaces 3c and 3d. The end surfaces 3e oppose each other in the direction D2. The second direction D2 includes a direction parallel to the side surfaces 3a and 3b and the side surfaces 3c and 3d, and is orthogonal to the first direction D1 and the third direction D3. The direction D2 includes a direction orthogonal to the end surfaces 3e.

The pair of side surfaces 3c and 3d extend in the first direction D1 to couple the pair of side surfaces 3a and 3b. The pair of side surfaces 3c and 3d also extend in the second direction D2. The pair of end surfaces 3e extend in the direction D1 to couple the pair of side surfaces 3a and 3b. The pair of end surfaces 3e also extend in the third direction D3.

The side surface 3a and the side surface 3c are adjacent to the end surfaces 3e and to each other. The side surface 3a and the side surface 3c may be directly adjacent to each other, or may be indirectly adjacent to each other with a ridge portion. The side surface 3a and the side surface 3d are adjacent to the end surfaces 3e and to each other. The side surface 3a and the side surface 3d may be directly adjacent to each other, or may be indirectly adjacent to each other with a ridge portion.

The multilayer capacitor C1 is solder-mounted on an electronic device, for example. The electronic device includes, for example, a circuit board or an electronic component. In the multilayer capacitor C1, for example, the side surface 3a opposes the electronic device. In this case, the side surface 3a is arranged to constitute a mounting surface. The side surface 3a includes the mounting surface.

For example, a length of the element body 3 in the second direction D2 is larger than a length of the element body 3 in the first direction D1 and larger than a length of the element body 3 in the third direction D3. For example, the second direction D2 includes a longitudinal direction of the element body 3. The length of the element body 3 in the first direction D1 and the length of the element body 3 in the third direction D3 may be equal to each other. The length of the element body 3 in the first direction D1 and the length of the element body 3 in the third direction D3 may be different from each other.

The length of the element body 3 in the first direction D1 is 0.1 to 3.2 mm. The length of the element body 3 in the second direction D2 is 0.2 to 7.5 mm. The length of the element body 3 in the third direction D3 is 0.1 to 6.3 mm. In the element body 3, for example, the second direction D2 is a longitudinal direction. The length of the element body 3 in the first direction D1 is a height of the element body 3. The length of the element body 3 in the second direction D2 is a longitudinal length of the element body 3. The length of the element body 3 in the third direction D3 is a width of the element body 3. For example, the height of the element body 3 is 2.5 mm, the width of the element body 3 is 2.5 mm, the longitudinal length of the element body 3 is 3.2 mm.

The element body 3 includes four ridge portions 3g, four ridge portions 3i, and four ridge portions 3j. The ridge portions 3g are located between the end surfaces 3e and the side surfaces 3a and 3b. The ridge portions 3i are located between the end surfaces 3e and the side surfaces 3c and 3d. The ridge portions 3j are located between the side surfaces 3a and 3b and the side surfaces 3c and 3d. For example, the ridge portions 3g, 3i, and 3j are rounded to be curved. For example, the element body 3 is subjected to what is called a round chamfering process. The end surfaces 3e and the side surfaces 3a and 3b are indirectly adjacent to each other with the ridge portion 3g interposed therebetween. The end surfaces 3e and the side surfaces 3c and 3d are indirectly adjacent to each other with the ridge portion 3i interposed therebetween. The side surfaces 3a and 3b and the side surfaces 3c and 3d are indirectly adjacent to each other with the ridge portion 3j interposed therebetween.

As illustrated in FIGS. 2 to 6, the element body 3 includes a region R1, a region R2, and a region R3. The region R1 does not include the side surface 3c and the side surface 3d. The region R2 includes the side surface 3c. The region R2 includes, for example, the entire side surface 3c. The region R3 includes the side surface 3d. The region R3 includes, for example, the entire side surface 3d. The region R1 is positioned between the region R2 and the region R3 in the third direction D3. The region R1 is positioned away from the side surface 3c and the side surface 3d.

A height of the region R2 is equal to a height of the region R3. The height of the region R2 is a length of the region R2 in the first direction D1. The height of the region R3 is a length of the region R3 in the first direction D1. A width of the region R2 is equal to a width of the region R3. The width of the region R2 is a length of the region R2 in the second direction D2. The width of the region R3 is a length of the region R3 in the second direction D2. A thickness of the region R2 is equal to a thickness of the region R3. The thickness of the region R2 is a length of the region R2 in the third direction D3. The thickness of the region R3 is a length of the region R3 in the third direction D3. The thickness of the region R2 may not be equal to the thickness of the region R3. The thickness of the region R2 may be different from the thickness of the regions R3.

For example, when the region R1 includes a first region, the region R2 may include a second region, and the region R3 may include a third region.

The element body 3 includes a dielectric material. The region R1 includes a first dielectric material. The first dielectric material includes, for example, BaTiO₃-based dielectric ceramic, Ba(Ti, Zr)O₃-based dielectric ceramic, or (Ba, Ca)TiO₃-based dielectric ceramic. The region R2 and the region R3 include a second dielectric material different from the first dielectric material. The second dielectric material includes, for example, CaZrO₃-based dielectric ceramic, SrTiO₃-based dielectric ceramic, or (Ca, Sr)(Zr, Ti)O₃-based dielectric ceramic. The second dielectric material has, for example, a dielectric constant smaller than a dielectric constant of the first dielectric material.

The element body 3 is configured through laminating a plurality of dielectric layers in the first direction D1. The element body 3 includes a plurality of laminated dielectric layers. In the element body 3, a lamination direction of the plurality of dielectric layers coincides with the first direction D1. Each dielectric layer includes, for example, a sintered body of a ceramic green sheet including the dielectric material. In the actual element body 3, each of the dielectric layers is integrated to such an extent that a boundary between the dielectric layers cannot be visually recognized.

Obtaining the element body 3 includes, for example, preparing a ceramic green sheet including the first dielectric material and a ceramic green sheet including the second dielectric material, and combining these ceramic green sheets to obtain a sheet laminate. Therefore, one dielectric layer includes, for example, a portion including the first dielectric material and a portion including the second dielectric material.

As illustrated in FIGS. 1 to 6, the electrical insulation film EI is disposed on the element body 3. The electrical insulation film EI is disposed directly on the element body 3. The electrical insulation film EI includes a film portion EIa. For example, the electrical insulation film EI includes only the film portion EIa. The film portion EIa is disposed on the side surface 3a. The film portion EIa covers the side surface 3a and is in direct contact with the side surface 3a. The film portion EIa is positioned only on the side surface 3a.

The electrical insulation film EI has, for example, an electrical resistivity higher than an electrical resistivity of the element body 3. The electrical resistivity of the element body 3 includes a volume resistivity of the element body 3 or a surface resistivity of the element body 3. The electrical insulation film EI may have the electrical resistivity higher than the volume resistivity of the element body 3 and higher than the surface resistivity of the element body 3.

The electrical insulation film EI includes, for example, an electrical insulation thin film. The electrical insulation thin film includes, for example, a sputtered film or a silicon oxide film. The silicon oxide film includes, for example, a silicon dioxide film. The electrical insulation film EI may include an aluminum oxide film. An average thickness of the film portion EIa is, for example, is larger than or equal to 0.02 μm. The average thickness may be larger than or equal to 0.05 μm.

The plurality of external electrodes 5 are disposed on the element body 3. For example, the multilayer capacitor C1 includes a pair of external electrodes 5. The external electrodes 5 are disposed at both ends of the element body 3 in the second direction D2. Each of the external electrodes 5 is disposed on a corresponding end surface 3e of the pair of side surfaces 3e. For example, each of the external electrodes 5 is disposed on five surfaces of the side surfaces 3a, 3b, 3c, and 3d and end surface 3e, and the ridge portions 3g, 3i, and 3j as well as the electrical insulation film EI. The external electrodes 5 are disposed indirectly on the element body 3 with the electrical insulation film EI.

Each of the external electrodes 5 includes a plurality of electrode portions 5a, 5b, 5c, 5d, and 5e. The electrode portion 5a is disposed on both the side surface 3a and the ridge potion 3g. The electrode portion 5b is disposed on both the side surface 3b and the ridge portion 3g. The electrode portion 5c is disposed on both the side surface 3c and the ridge portion 3i. The electrode portion 5d is disposed on both the side surface 3d and the ridge portion 3i. The electrode portion 5e is disposed on the end surface 3e. The external electrode 5 also includes an electrode portion disposed on the ridge portion 3j. The electrode portions 5a, 5b, 5c, 5d, and 5e adjacent to each other are coupled to each other and electrically connected to each other.

Each of the external electrodes 5 includes a first electrode layer E1, a second electrode layer E2, and a third electrode layer E3. The third electrode layer E3 arranged to include an outermost layer of the external electrode 5. Each of the electrode portion 5a, 5c, 5d, and 5e includes the first electrode layer E1, the second electrode layer E2, and the third electrode layer E3. The electrode portion 5b includes the first electrode layer E1 and the third electrode layer E3. For example, the second electrode layer E2 includes a conductive resin layer. The conductive resin layer included in the second electrode layer E2 is positioned on both the side surface 3a and the side surface 3c. The conductive resin layer included in the second electrode layer E2 is positioned on both the side surface 3a and the side surface 3d.

The first electrode layer E1 of the electrode portion 5a is disposed on both the electrical insulation film EI and the ridge portion 3g. The first electrode layer E1 of the electrode portion 5a is formed on the electrical insulation film EI to cover a part of the electrical insulation film EI, and is formed on the element body 3 to cover the entirety of the ridge portion 3g. The first electrode layer E1 of the electrode portion 5a is in contact with the above-described part of the electrical insulation film EI and the entirety of the ridge portion 3g. The first electrode layer E1 of the electrode portion 5a is formed on the base 3 to cover a part of the ridge portion 3j. The first electrode layer E1 of the electrode portion 5a is in contact with the above-described part of the ridge portion 3j. In the electrode portion 5a, the first electrode layer E1 is in direct contact with both the electrical insulation film EI (film portion EIa) and the element body 3. The electrical insulation film EI is covered with the first electrode layer E1 in the above-described part and is exposed from the first electrode layer E1 in the remaining part excluding the above-described part. The above-described part of the electrical insulation film EI includes a partial region, of the electrical insulation film EI, closer to the end surface 3e. The first electrode layer E1 of the electrode portion 5a is positioned on the electrical insulation film EI. The side surface 3a includes a portion indirectly covered with the first electrode layer E1 and a portion exposed from the first electrode layer E1. The first electrode layer E1 may not be formed on the electrical insulation film EI. The first electrode layer E1 may not be disposed on the electrical insulation film EI.

The second electrode layer E2 of the electrode portion 5a is disposed on both the first electrode layer E1 and the electrical insulation film EI. The second electrode layer E2 of the electrode portion 5a is formed on the first electrode layer E1 to cover the first electrode layer E1, and is also formed on the electrical insulation film EI to cover a part of the electrical insulation film EI. The second electrode layer E2 of the electrode portion 5a is in contact with the entirety of the first electrode layer E1 and the above-described part of the electrical insulation film EI. The electrical insulation film EI includes a film portion EIa positioned on a region, of the side surface 3a, between the second electrode layer E2. In the electrode portion 5a, the second electrode layer E2 is in direct contact with both the first electrode layer E1 and the electrical insulation film EI (film portion EIa). In the electrode portion 5a, the second electrode layer E2 indirectly covers the side surface 3a such that the first electrode layer E1 and the electrical insulation film EI are positioned between the second electrode layer E2 and the side surface 3a. The second electrode layer E2 of the electrode portion 5a is positioned on the side surface 3a. A portion included in the second electrode layer E2 and positioned on the side surface 3a includes a layer portion positioned on the side surface 3a. The second electrode layer E2 includes the layer portion positioned on the side surface 3a. The second electrode layer E2 of the electrode portion 5a includes an end edge E2ae positioned on the electrical insulation film EI.

The third electrode layer E3 of the electrode portion 5a is disposed on the second electrode layer E2. In the electrode portion 5a, the third electrode layer E3 covers the second electrode layer E2. In the electrode portion 5a, the third electrode layer E3 is in contact with the second electrode layer E2. In the electrode portion 5a, the third electrode layer E3 is directly in contact with the second electrode layer E2. In the electrode portion 5a, the third electrode layer E3 is not directly in contact with the first electrode layer E1. The third electrode layer E3 of the electrode portion 5a is positioned on the electrical insulation film EI.

The first electrode layer E1 of the electrode portion 5b is disposed on both the side surface 3b and the ridge portion 3g. The first electrode layer E1 of the electrode portion 5b is formed to cover a part of the side surface 3b and the entirety of the ridge portion 3g. The first electrode layer E1 of the electrode portion 5b is in contact with the above-described part of the side surface 3b and the entirety of the ridge portion 3g. In the electrode portion 5b, the first electrode layer E1 is in direct contact with the element body 3. The side surface 3b is covered with the first electrode layer E1 in the above-described part, and is exposed from the first electrode layer E1 in the remaining part excluding the above-described part. The above-described part of the side surface 3b includes a partial region, of the side surface 3b, closer to the end surface 3e. The first electrode layer E1 of the electrode portion 5b is positioned on the side surface 3b. The first electrode layer E1 may not be formed on the side surface 3b. The first electrode layer E1 may not be disposed on the side surface 3b.

The third electrode layer E3 of the electrode portion 5b is disposed on the first electrode layer E1. In the electrode portion 5b, the third electrode layer E3 covers the first electrode layer E1. In the electrode portion 5b, the third electrode layer E3 is in contact with the first electrode layer E1. In the electrode portion 5b, the third electrode layer E3 is directly in contact with the first electrode layer E1. The third electrode layer E3 of the electrode portion 5b is positioned on the side surface 3b. The electrode portion 5b does not include the second electrode layer E2. The side surface 3b is not covered with the second electrode layer E2.

The first electrode layer E1 of the electrode portion 5c is disposed on both the side surface 3c and the ridge portion 3i. The first electrode layer E1 of the electrode portion 5c is formed to cover a part of the side surface 3c and the entirety of the ridge portion 3i. The first electrode layer E1 of the electrode portion 5c is in contact with the above-described part of the side surface 3c and the entirety of the ridge portion 3i. In the electrode portion 5c, the first electrode layer E1 is in direct contact with the element body 3. The side surface 3c is covered with the first electrode layer E1 in the above-described part, and is exposed from the first electrode layer E1 in the remaining part excluding the above-described part. The above-described part of the side surface 3c includes a partial region, of the side surface 3c, closer to the end surface 3e. The first electrode layer E1 of the electrode portion 5c is positioned on the side surface 3c. The first electrode layer E1 may not be formed on the side surface 3c. The first electrode layer E1 may not be disposed on the side surface 3c.

The second electrode layer E2 of the electrode portion 5c is disposed on both the first electrode layer E1 and the side surface 3c. In the electrode portion 5c, the second electrode layer E2 is formed to cover a part of the first electrode layer E1 and a part of the side surface 3c. In the electrode portion 5c, the second electrode layer E2 is in direct contact with the above-described part of the first electrode layer E1 and the above-described part of the side surface 3c. The second electrode layer E2 of the electrode portion 5c is formed to cover the above-described part of the first electrode layer E1 of the electrode portion 5c. The above-described part of the side surface 3c includes, for example, a corner region, of the side surface 3c, closer to both the side surface 3a and the end surface 3e. In the electrode portion 5c, the second electrode layer E2 indirectly covers the above-described part of the side surface 3c such that the first electrode layer E1 is positioned between the second electrode layer E2 and the side surface 3c. The first electrode layer E1 of the electrode portion 5c is covered with the second electrode layer E2 in the above-described part, and is exposed from the second electrode layer E2 in the remaining part excluding the above-described part. The second electrode layer E2 of the electrode portion 5c is positioned on the side surface 3c. A portion included in the second electrode layer E2 and positioned on the side surface 3c includes a layer portion positioned on the side surface 3c. The second electrode layer E2 includes the layer portion positioned on the side surface 3c. The second electrode layer E2 of the electrode portion 5c includes the edge E2cₑ positioned on the side surface 3c.

The third electrode layer E3 of the electrode portion 5c is disposed on both the first electrode layer E1 and the second electrode layer E2. In the electrode portion 5c, the third electrode layer E3 covers the entirety of the second electrode layer E2 and also covers the entirety of a portion that is included in the first electrode layer E1 and is exposed from the second electrode layer E2. In the electrode portion 5c, the third electrode layer E3 is in contact with the entirety of the second electrode layer E2 and also in contact with the entirety of the portion that is included in the first electrode layer E1 and is exposed from the second electrode layer E2. In the electrode section 5c, the third electrode layer E3 is directly in contact with both the first electrode layer E1 and the second electrode layer E2. The third electrode layer E3 of the electrode portion 5c is positioned on the side surface 3c.

The electrode portion 5c includes a plurality of regions 5c1 and 5c2. For example, the electrode portion 5c includes only two regions 5c1 and 5c2. The region 5c2 is positioned closer to the side surface 3a than the region 5c1. The region 5c1 includes the first electrode layer E1 and the third electrode layer E3. The region 501 does not include the second electrode layer E2. The region 5c2 includes the first electrode layer E1, the second electrode layer E2, and the third electrode layer E3. The region 5c1 includes a region in which the first electrode layer E1 is exposed from the second electrode layer E2. The region 5c2 includes a region in which the first electrode layer E1 is covered with the second electrode layer E2.

The first electrode layer E1 of the electrode portion 5d is disposed on both the side surface 3d and the ridge portion 3i. The first electrode layer E1 of the electrode portion 5d is formed to cover a part of the side surface 3d and the entirety of the ridge portion 3i. The first electrode layer E1 of the electrode portion 5d is in contact with the above-described part of the side surface 3d and the entirety of the ridge portion 3i. In the electrode portion 5d, the first electrode layer E1 is in direct contact with the element body 3. The side surface 3d is covered with the first electrode layer E1 in the above-described part, and is exposed from the first electrode layer E1 in the remaining part excluding the above-described part. The above-described part of the side surface 3d includes a partial region, of the side surface 3d, closer to the end surface 3e. The first electrode layer E1 of the electrode portion 5d is positioned on the side surface 3d. The first electrode layer E1 may not be formed on the side surface 3d. The first electrode layer E1 may not be disposed on the side surface 3d.

The second electrode layer E2 of the electrode portion 5d is disposed on both the first electrode layer E1 and the side surface 3d. In the electrode portion 5d, the second electrode layer E2 is formed to cover a part of the first electrode layer E1 and a part of the side surface 3d. In the electrode portion 5d, the second electrode layer E2 is in direct contact with the above-described part of the first electrode layer E1 and the above-described part of the side surface 3d. The second electrode layer E2 of the electrode portion 5d is formed to cover the above-described part of the first electrode layer E1 of the electrode portion 5d. The above-described part of the side surface 3d includes, for example, a corner region, of the side surface 3d, closer to both the side surface 3a and the end surface 3e. In the electrode portion 5d, the second electrode layer E2 indirectly covers the above-described part of the side surface 3d such that the first electrode layer E1 is positioned between the second electrode layer E2 and the side surface 3d. The first electrode layer E1 of the electrode portion 5d is covered with the second electrode layer E2 in the above-described part, and is exposed from the second electrode layer E2 in the remaining part excluding the above-described part. The second electrode layer E2 of the electrode portion 5d is positioned on the side surface 3d. A portion included in the second electrode layer E2 and positioned on the side surface 3d includes a layer portion positioned on the side surface 3d. The second electrode layer E2 includes the layer portion positioned on the side surface 3d. The second electrode layer E2 of the electrode portion 5d includes the edge E2de positioned on the side surface 3d.

The third electrode layer E3 of the electrode portion 5d is disposed on both the first electrode layer E1 and the second electrode layer E2. In the electrode portion 5d, the third electrode layer E3 covers the entirety of the second electrode layer E2 and also covers the entirety of a portion that is included in the first electrode layer E1 and is exposed from the second electrode layer E2. In the electrode portion 5d, the third electrode layer E3 is in contact with the entirety of the second electrode layer E2 and also in contact with the entirety of the portion that is included in the first electrode layer E1 and is exposed from the second electrode layer E2. In the electrode section 5d, the third electrode layer E3 is directly in contact with both the first electrode layer E1 and the second electrode layer E2. The third electrode layer E3 of the electrode portion 5d is positioned on the side surface 3d.

The electrode portion 5d includes a plurality of regions 5d1 and 5d2. For example, the electrode portion 5d includes only two regions 5d1 and 5d2. The region 5d2 is positioned closer to the side surface 3a than the region 5d1. The region 5d1 includes the first electrode layer E1 and the third electrode layer E3. The region 5d1 does not include the second electrode layer E2. The region 5d2 includes the first electrode layer E1, the second electrode layer E2, and the third electrode layer E3. The region 5d1 includes a region in which the first electrode layer E1 is exposed from the second electrode layer E2. The region 5d2 includes a region in which the first electrode layer E1 is covered with the second electrode layer E2.

The first electrode layer E1 of the electrode potion 5e is disposed on the end surface 3e. The first electrode layer E1 of the electrode potion 5e is formed to cover the entire end surface 3e. The first electrode layer E1 of the electrode portion 5e is in contact with the entire end surface 3e. In the electrode section 5e, the first electrode layer E1 is directly in contact with the end surface 3e.

The second electrode layer E2 of the electrode portion 5e is disposed on the first electrode layer E1. In the electrode portion 5e, the second electrode layer E2 is formed to cover a part of the first electrode layer E1. In the electrode portion 5e, the second electrode layer E2 is in direct contact with the above-described part of the first electrode layer E1. The second electrode layer E2 of the electrode portion 5e is formed to cover the above-described part of the first electrode layer E1 of the electrode portion 5e. In the electrode portion 5e, the second electrode layer E2 indirectly covers a part of the end surface 3e such that the first electrode layer E1 is positioned between the second electrode layer E2 and the end surface 3e. The above-described part of the end surface 3e includes, for example, a partial region, of the end surface 3e, closer to the side surface 3a. The first electrode layer E1 of the electrode portion 5e is covered with the second electrode layer E2 in the above-described part and is exposed from the second electrode layer E2 in the remaining part excluding the above-described part. A portion included in the second electrode layer E2 and positioned on the end surface 3e includes a layer portion positioned on the end surface 3e. The second electrode layer E2 includes the layer portion positioned on the end surface 3e.

The third electrode layer E3 of the electrode portion 5e is disposed on both the first electrode layer E1 and the second electrode layer E2. In the electrode portion 5e, the third electrode layer E3 covers the entirety of the second electrode layer E2 and also covers the entirety of a portion that is included in the first electrode layer E1 and is exposed from the second electrode layer E2. In the electrode portion 5e, the third electrode layer E3 is in contact with the entirety of the second electrode layer E2 and also in contact with the entirety of the portion that is included in the first electrode layer E1 and is exposed from the second electrode layer E2. In the electrode portion 5e, the third electrode layer E3 is directly in contact with both the first electrode layer E1 and the second electrode layer E2. The third electrode layer E3 of the electrode portion 5e is positioned on the end surface 3e.

The electrode portion 5e may not include the second electrode layer E2. In a configuration in which the electrode portion 5e does not include the second electrode layer E2, the third electrode layer E3 included in the electrode portion 5e covers the entirety of the first electrode layer E1 and is directly in contact with the first electrode layer E1.

The electrode portion 5e includes a plurality of regions 5e₁ and 5e₂. For example, the electrode portion 5e includes only two regions 5e₁ and 5e₂. The region 5e₂ is positioned closer to the side surface 3a than the region 5e₁. The region 5e₁ includes the first electrode layer E1 and the third electrode layer E3. The region 5e₁ does not include the second electrode layer E2. The region 5e₂ includes the first electrode layer E1, the second electrode layer E2, and the third electrode layer E3. In the electrode portion 5e, the third electrode layer E3 is formed to cover the entire end surface 3e when viewed from the first direction D1. For example, the third electrode layer E3 indirectly covers the entire end surface 3e. The region 5e₁ includes a region in which the first electrode layer E1 is exposed from the second electrode layer E2. The region 5e₂ includes a region in which the first electrode layer E1 is covered with the second electrode layer E2.

The electrical insulation film EI includes a portion covered with the external electrode 5 and a portion exposed from the external electrode 5. The film portion EIa includes a portion covered with the electrode portion 5a and a portion exposed from the electrode portion 5a. The portion that is included in the electrical insulation film EI (film portion Ela) and is exposed from the external electrode 5 (electrode portion 5a) is positioned on a region, of the side surface 3a, between the pair of external electrodes 5 (pair of electrode portions 5a). The electrical insulation film EI includes a film portion that is at least positioned on the region, of the side surface 3a, between the pair of external electrodes 5. The electrical insulation film EI includes the film portion EIa that is at least positioned on a region, of the side surface 3a, exposed from the pair of external electrodes 5.

The first electrode layer E1 is formed from sintering electrically conductive paste applied onto the surface of the element body 3. The first electrode layer E1 is formed to cover the above-described part of each of the side surface 3a, 3b, 3c, and 3d, the end surface 3e, and the ridge portions 3g, 3i, and 3j. The first electrode layer E1 is formed from sintering a metal component included in the electrically conductive paste. The metal component included in the electrically conductive paste includes, for example, metal particles. The first electrode layer E1 includes a sintered metal layer. The first electrode layer E1 includes the sintered metal layer formed on the element body 3. For example, the first electrode layer E1 includes a sintered metal layer made of Cu. The first electrode layer E1 may include a sintered metal layer made of Ni. The first electrode layer E1 includes a base metal. The electrically conductive paste includes, for example, particles made of Cu or Ni, a glass component, an organic binder, and an organic solvent. The first electrode layers E1 included in the electrode portions 5a, 5b, 5c, 5d, and 5e are integrally formed.

The second electrode layer E2 is formed from curing electrically conductive resin paste applied onto the first electrode layer E1. The second electrode layer E2 is formed on both the first electrode layer E1 and the element body 3. The first electrode layer E1 includes an underlying metal layer for forming the second electrode layer E2. The second electrode layer E2 includes an electrically conductive resin layer that covers the first electrode layer E1. The electrically conductive resin paste includes, for example, a resin, an electrically conductive material, and an organic solvent. The resin includes, for example, a thermosetting resin. The conductive material includes, for example, metal particles. The metal particles include, for example, silver particles or copper particles. The thermosetting resin includes, for example, a phenol resin, an acrylic resin, a silicone resin, an epoxy resin, or a polyimide resin. The second electrode layer E2 is in contact with a part of the ridge portion 3j. The second electrode layers E2 included in the electrode portions 5a, 5c, 5d, and 5e are integrally formed.

The third electrode layer E3 is formed on both the second electrode layer E2 and the first electrode layer E1 (the portion exposed from the second electrode layer E2) using a plating method. The third electrode layer E3 may have a multilayer structure. In this case, the third electrode layer E3 includes, for example, an Ni plating layer and a solder plating layer. The Ni plating layer is formed on both the second electrode layer E2 and the first electrode layer E1. The solder plating layer is formed on the Ni plating layer. The solder plating layer covers the Ni plating layer. The Ni plating layer has better solder leach resistance than the metal included in the second electrode layer E2. The third electrode layer E3 may include an Sn plating layer, a Cu plating layer, or an Au plating layer instead of the Ni plating layer. The solder plating layer includes, for example, an Sn plating layer, an Sn—Ag alloy plating layer, an Sn—Bi alloy plating layer, or an Sn—Cu alloy plating layer. The third electrode layers E3 included in the electrode portions 5a, 5b, 5c, 5d, and 5e are integrally formed.

The second electrode layer E2 continuously covers a part of the side surface 3c, a part of the side surface 3a, a part of the side surface 3d, and a part of a corresponding end surface 3e of the pair of end surfaces 3e. The second electrode layer E2 continuously covers, for example, only a part of each of the side surface 3c and 3d, only a part of the side surface 3a, and only a part of the end surface 3e. The second electrode layer E2 includes a portion continuously covering only a part of each of the side surface 3c and 3d, only a part of the side surface 3a, and only a part of the end surface 3e. The above-described part of the end surface 3e includes a portion, of the end surface 3e, closer to the side surface 3a. The above-described part of the side surface 3c includes a portion, of the side surface 3c, closer to the side surface 3a, and the above-described part of the side surface 3d includes a portion, of the side surface 3d, closer to the side surface 3a. The second electrode layer E2 covers the entire one ridge portion 3g, only a part of the ridge portion 3i, and only a part of the ridge portion 3j. A part of a potion, of the first electrode layer E1, covering the ridge portion 3i is exposed from the second electrode layer E2. For example, each first electrode layer E1 included in the regions 5c₁, 5d₁, and 5e₁ is exposed from the second electrode layer E2.

In a configuration in which the electrode portion 5e does not include the second electrode layer E2, the second electrode layer E2 continuously covers only a part of each of the side surface 3c and 3d and only a part of the side surface 3a. The second electrode layer E2 includes a portion continuously covering only a part of the side surface 3a and only of part of each of the side surface 3c and 3d.

The film portion EIa is disposed at least on a region, of the side surface 3a, between the pair of external electrodes 5. The side surfaces 3c and 3d, the pair of end surfaces 3e, and each of the ridge portions 3g, 3i, and 3j are exposed from the electrical insulation film EI. The electrical insulation film EI includes the film portion EIa positioned on a region, of the side surface 3a, between the second electrode layers E2.

The multilayer capacitor C1 includes the plurality of internal electrodes 7 and the plurality of internal electrodes 9. Each of the internal electrodes 7 and 9 is included in an internal conductor disposed in the element body 3. Each of the internal electrodes 7 and 9 is electrically connected to a corresponding external electrode 5 of the pair of external electrodes 5. Each of the internal electrodes 7 and 9 is made of an electrically conductive material that is commonly used as an internal conductor of a multilayer electronic component. The electrically conductive material includes, for example, a base metal. The electrically conductive material includes, for example, Ni or Cu. Each of the internal electrodes 7 and 9 is configured as a sintered body of electrically conductive paste including the electrically conductive material described above. For example, the internal electrodes 7 and 9 include Ni.

The plurality of internal electrodes 7 and the plurality of internal electrodes 9 are alternately disposed in the first direction D1. The internal electrode 7 and the internal electrode 9 are disposed in the element body 3 to be disposed in the first direction D1. The internal electrode 7 and the internal electrode 9 are disposed in different positions (layers) in the first direction D1. The internal electrodes 7 and the internal electrodes 9 are alternately disposed in the element body 3 to oppose each other in the first direction D1 with an interval therebetween. The internal electrodes 7 and the internal electrodes 9 have different polarities from each other.

Each internal electrode 7 and 9 is positioned in a plane substantially parallel to the side surfaces 3a and 3b. The internal electrode 7 and the internal electrode 9 oppose each other in the first direction D1. For example, a direction in which the internal electrode 7 and the internal electrode 9 oppose each other is substantially orthogonal to a direction parallel to the side surfaces 3a and 3b. The direction in which the internal electrode 7 and the internal electrode 9 oppose each other may include the first direction D1. The direction parallel to the side surfaces 3a and 3b may include the second direction D2 and the third direction D3. For example, the internal electrode 7 and the internal electrode 9 oppose each other in a direction orthogonal to both the direction in which the pair of end surfaces 3e oppose each other and the direction in which the side surface 3c and the side surface 3d oppose each other. The direction in which the pair of end surfaces 3e oppose each other may include the second direction D2. The direction in which the side surface 3c and the side surface 3d oppose each other may include the third direction D3. The direction orthogonal to both the direction in which the pair of end surfaces 3e oppose each other and the direction in which the side surface 3c and the side surface 3d oppose each other may include the first direction D1.

Each of the plurality of internal electrodes 7 and 9 includes one end exposed to a corresponding end surface 3e of the pair of end surfaces 3e. The above-described one end included in each of the plurality of internal electrodes 7 and 9 is covered by a corresponding electrode portion 5e of the plurality of electrode portions 5e. For example, the above-described one end is entirely covered with the corresponding electrode portion 5e. The internal electrode 7 and the internal electrode 9 are directly connected to the corresponding electrode portion 5e. The internal electrode 7 and the internal electrode 9 are electrically connected to a corresponding external electrode 5 of the plurality of external electrodes 5. Each of the plurality of internal electrodes 7 includes an end 7c closer to the side surface 3c and an end 7d closer to the side surface 3d. Each of the plurality of internal electrodes 9 includes an end 9c closer to the side surface 3c and an end 9d closer to the side surface 3d. The ends 7c and 7d, and the ends 9c and 9d are not exposed to an outer surface of the element body 3

Each end surface 3e is exposed from the electrical insulation film EI (film portion EIa), and the above-described one end of each of the plurality of internal electrodes 7 and 9 includes a region exposed from the electrical insulation film EI. For example, the above-described one end of each of the plurality of internal electrodes 7 and 9 includes only the region exposed from the electrical insulation film EI. The entirety of the above-described one end of each of the plurality of internal electrodes 7 and 9 is exposed from the electrical insulation film EI. The electrical insulation film EI (film portion EIa) opposes the plurality of internal electrodes 7 and 9 in the first direction D1.

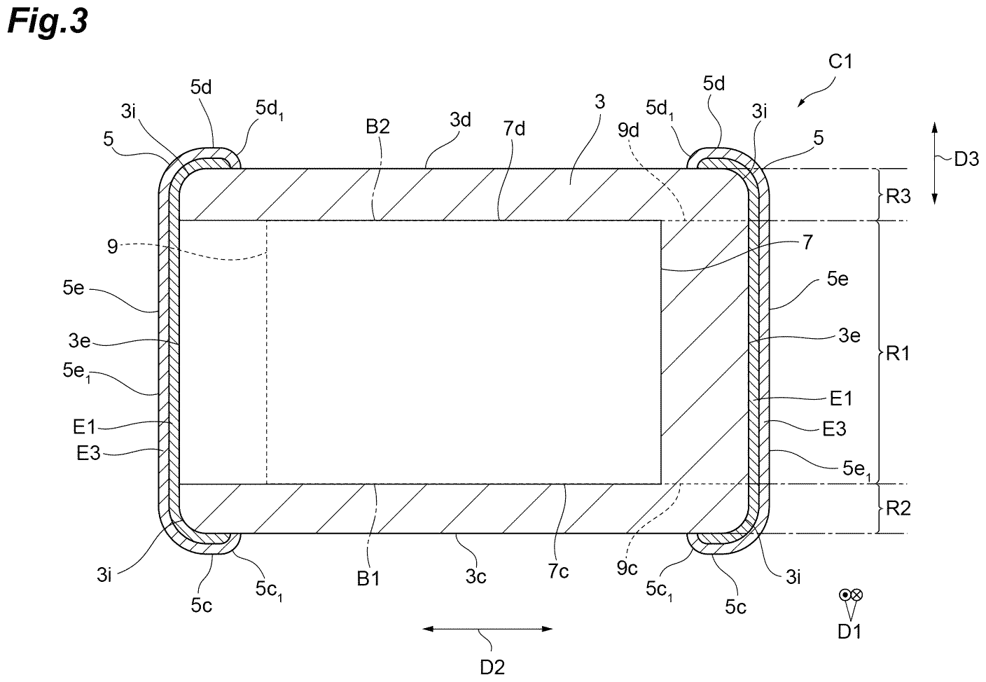

As illustrated in FIGS. 3 to 6, the plurality of internal electrodes 7 and 9 are disposed in the region R1. The end 7c included in each of the plurality of internal electrodes 7 extends in the second direction D2 along an end B1, of the in region R1, opposing the side surface 3c. The end 9c included in each of the plurality of internal electrodes 9 extends in the second direction D2 along the end B1. The end 7d included in each of the plurality of internal electrodes 7 extends in the second direction D2 along an end B2, of the region R1, opposing the side surface 3d. The end 9d included in each of the plurality of internal electrodes 9 extends in the second direction D2 along the end B2. For example, when viewed from the first direction D1, the ends 7c and 9c correspond to the end B1, and the ends 7d and 9d correspond to the end B2. The plurality of internal electrodes 7 and 9 are not disposed in the region R2 and the region R3.

For example, the region R2 is in contact with the ends 7c and 9c of the internal electrodes 7 and 9. Therefore, the region R2 includes a region between a plane including the ends 7c and 9c and the side surface 3c. For example, the region R3 is in contact with the ends 7d and 9d of the internal electrodes 7 and 9. Therefore, the region R3 includes a region between a plane including the ends 7d and 9d and the side surface 3d. A length of the region R1 in the third direction D3 is, for example, equal to a length of the internal electrodes 7 and 9 in the third direction D3.

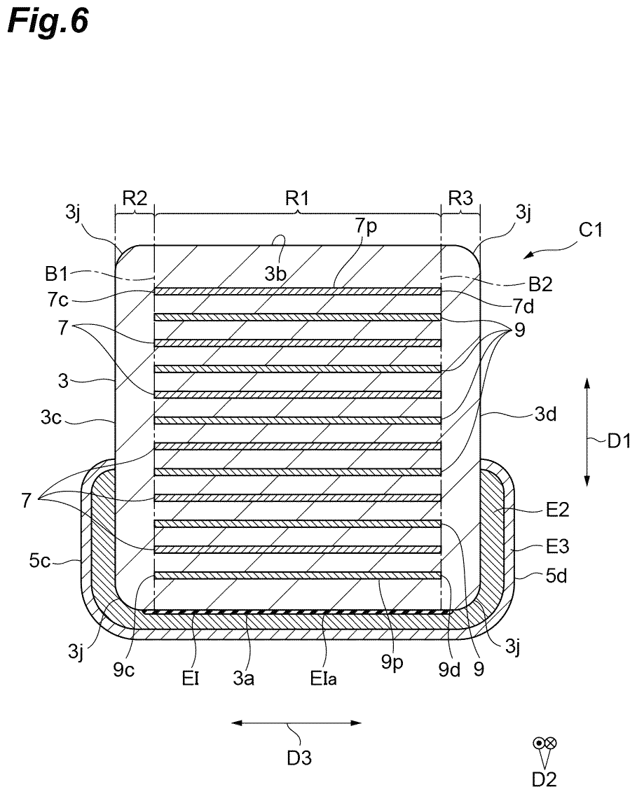

As illustrated in FIGS. 2 and 6, the plurality of internal electrodes 9 includes an outermost internal electrode 9p adjacent to the side surface 3a. When the outermost internal electrode 9p and the second electrode layer E2 that is not electrically connected to the outermost internal electrode 9p are viewed in a direction orthogonal to the side surface 3c, for example, in the third direction D3, the outermost internal electrode 9p overlaps with the second electrode layer E2 that is not electrically connected to the outermost internal electrode 9p. For example, the plurality of internal electrodes 7 may include an outermost internal electrode 7p adjacent to the side surface 3b. When the outermost internal electrode 7p included in the plurality of internal electrodes 7 and the second electrode layer E2 that is not electrically connected to the outermost internal electrode included in the plurality of internal electrodes 7 are viewed in a direction orthogonal to the side surface 3d, for example, in the third direction D3, the outermost internal electrode included in the plurality of internal electrodes 7 may overlap with the second electrode layer E2 that is not electrically connected to the outermost internal electrode included in the plurality of internal electrodes 7.

In the multilayer capacitor C1, the region R2 including the side surface 3c has a dielectric constant smaller than a dielectric constant of the region R1. Therefore, the multilayer capacitor C1 prevents occurrence of a leakage current in the region R2. Even when a metal particle included in the second electrode layer E2 positioned on the side surface 3c ionize, an electron tends not to be supplied to a metal ion. A metal tends not to be deposited on the side surface 3c.

In the multilayer capacitor C1, the film portion EIa included in the electrical insulation film EI is positioned on the region, of the side surface 3a, between the second electrode layers E2. Even when a metal particle included in the second electrode layer E2 positioned on the side surface 3a ionize, the film portion EIa prevents a generated metal ion from reacting with an electron resulting from a leakage current. The electron tends not to be supplied to the metal ion. A metal tends not to be deposited on the side surface 3a.

Consequently, the multilayer capacitor C1 reduces occurrence of migration even in a configuration in which the external electrode 5 includes the second electrode layer E2 positioned on both the side surface 3c and the side surface 3a.

In the multilayer capacitor C1, the electrical insulation film EI is disposed only on the side surface 3a. The electrical insulation film EI can be easily formed on the element body 3, for example, as compared with a configuration in which the electrical insulation film EI is disposed on the side surface 3a, the side surface 3c, and the side surface 3d.

In the multilayer capacitor C1, the element body 3 includes the side surface 3d opposing the side surface 3c, and includes the region R3 including the side surface 3d and having a dielectric constant smaller than the dielectric constant of the region R1. The second electrode layer E2 is positioned on the side surface 3d.

The multilayer capacitor C1 prevents occurrence of a leakage current in the region R3. Even when a metal particle included in the second electrode layer E2 positioned on the side surface 3d ionize, an electron tends not to be supplied to a metal ion. A metal tends not to be deposited on the side surface 3d. Therefore, the multilayer capacitor C1 reduces occurrence of migration even in a configuration in which the external electrode 5 includes the second electrode layer E2 positioned on the side surface 3d.

In the multilayer capacitor C1, the plurality of internal electrodes 7 and 9 oppose each other in the direction orthogonal to both the direction in which the pair of end surfaces 3e oppose each other and the direction in which the side surface 3c and the side surface 3d oppose each other. In the multilayer capacitor C1, the plurality of internal electrodes 7 and 9 oppose each other in the first direction D1, for example.

In the multilayer capacitor C1, an electron tends to be supplied as a leakage current from at least one of the internal electrodes 7 and 9 opposing each other in the first direction D1 to the second electrode layer E2 positioned on the side surface 3a. However, as described above, the film portion EIa prevents the generated metal ion from reacting with the electron. Therefore, in the multilayer capacitor C1, the occurrence of the migration is reliably prevented.

In the multilayer capacitor C1, the plurality of internal electrodes 9 include an outermost internal electrode 9p adjacent to the side surface 3a. When the outermost internal electrode adjacent 9p to the side surface 3a and the second electrode layer E2 that is not electrically connected to the outermost internal electrode 9p adjacent to the side surface 3a are viewed in the direction orthogonal to the side surface 3c, the outermost internal electrode 9p adjacent to the side surface 3a overlaps with the second electrode layer E2 that is not electrically connected to the outermost internal electrode 9p adjacent to the side surface 3a.

In the multilayer capacitor C1, an electron tends to be supplied as a leakage current from the outermost internal electrode 9p adjacent to the side surface 3a to the second electrode layer E2 positioned on the side surfaces 3c and 3d. However, as described above, the electron tends not to be supplied to the metal ion in the region R2. Therefore, in multilayer capacitor C1, the occurrence of the migration is reliably prevented.

Even in a configuration where a distance between the outermost internal electrode adjacent to the side surface 3a and the side surface 3a is small, as described above, the occurrence of migration is reliably prevented. That is, even in a configuration where the number of layers of the plurality of internal electrodes 7 and 9 is increased, the occurrence of migration is reliably prevented.

In the multilayer capacitor C1, the second electrode layer E2 continuously covers a part of the side surface 3c, a part of the side surface 3a, a part of the side surface 3d, and a part of the corresponding end surface 3e.

The multilayer capacitor C1 tends to lead to a decrease in the amount of conductive resin paste used to form the second electrode layer E2, as compared with a configuration in which the second electrode layer E2 continuously covers a part of the side surface 3c, a part of the side surface 3a, a part of the side surface 3d, and the entire corresponding end surface 3e. The decrease in the amount of the conductive resin paste tends to lead to a decrease in a length of the second electrode layer E2 in the direction in which the pair of end surfaces 3e oppose each other and an increase in a distance between the pair of external electrodes 5 on the side surfaces 3c, 3a, and 3d. The increase in the distance between the pair of external electrodes 5 reduces an electric field between the pair of external electrodes 5. Therefore, the generated metal ion tends not to migrate from the second electrode layer E2. Consequently, the configuration in which the second electrode layer E2 continuously covers a part of the side surface 3c, a part of the side surface 3a, a part of the side surface 3d, and a part of the corresponding end surface 3e can further prevent the occurrence of the migration.

The multilayer capacitor C1 reduces ESR (Equivalent Series Resistance), as compared with a configuration in which the second electrode layer E2 continuously covers a part of the side surface 3c, a part of the side surface 3a, a part of the side surface 3d, and the entire corresponding end surface 3e.

The multilayer capacitor C1 includes the element body 3 of the rectangular parallelepiped shape, the pair of external electrodes 5, the plurality of internal electrodes 7 and 9, the electrical insulation film EI disposed on the element body 3. The element body 3 includes the pair of end surfaces 3e opposing each other, and the side surface 3c and the side surface 3a adjacent to each other and to the pair of end surfaces 3e. The pair of external electrodes 5 are disposed on both ends of the element body 3 in the direction in which the pair of end surfaces 3e oppose each other, and each includes the second electrode layer E2 positioned on both the side surface 3c and the side surface 3a. The plurality of internal electrodes 7 and 9 are disposed in the element body 3 and are each electrically connected to the corresponding external electrode 5 of the plurality of external electrodes 5. The side surface 3c has a surface electrical resistivity larger than a surface electrical resistivity of the side surface 3a. The electrical insulation film EI includes the film portion EIa positioned on the region, of the side surface 3a, between the second electrode portions E2.

In the multilayer capacitor C1, the side surface 3c has the surface electrical resistivity larger than the surface electrical resistivity of the side surface 3a. Therefore, the multilayer capacitor C1 prevents occurrence of a leakage current in the side surface 3c. Even when a metal particle included in the second electrode layer E2 positioned on the side surface 3c ionize, an electron tends not to be supplied to a metal ion. A metal tends not to be deposited on the side surface 3c.

In the multilayer capacitor C1, the film portion EIa included in the electrical insulation film EI is positioned on the region, of the side surface 3a, between the second electrode layers E2. Even when a metal particle included in the second electrode layer E2 positioned on the side surface 3a ionize, the film portion EIa prevents a generated metal ion from reacting with an electron resulting from a leakage current. The electron tends not to be supplied to the metal ion. A metal tends not to be deposited on the side surface 3a.

Consequently, the multilayer capacitor C1 reduces occurrence of migration even in a configuration in which the external electrode 5 includes the second electrode layer E2 positioned on both the side surface 3c and the side surface 3a.

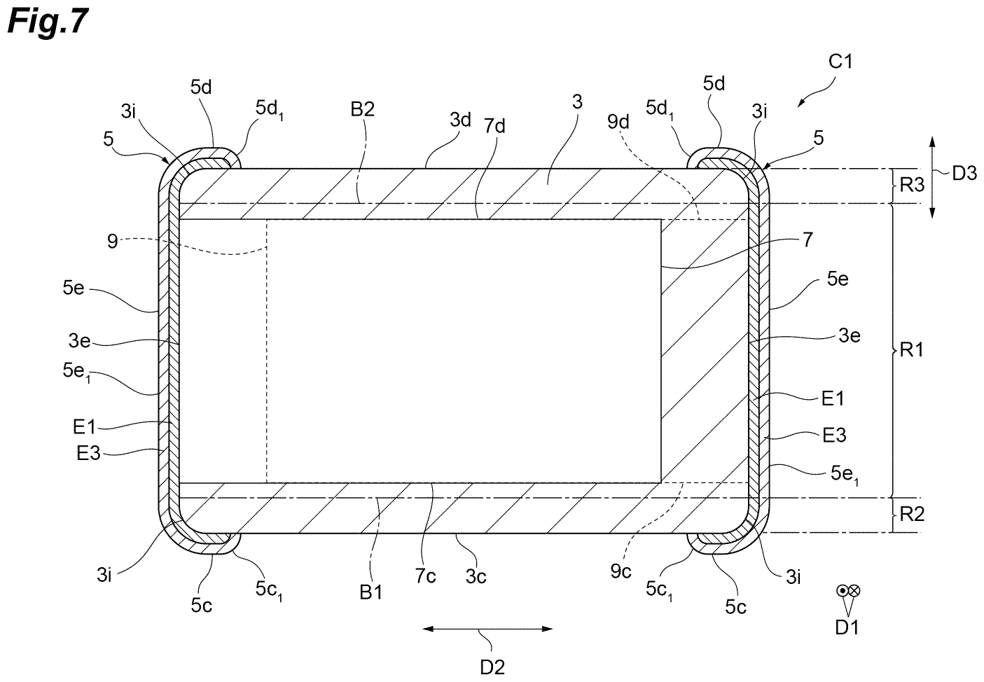

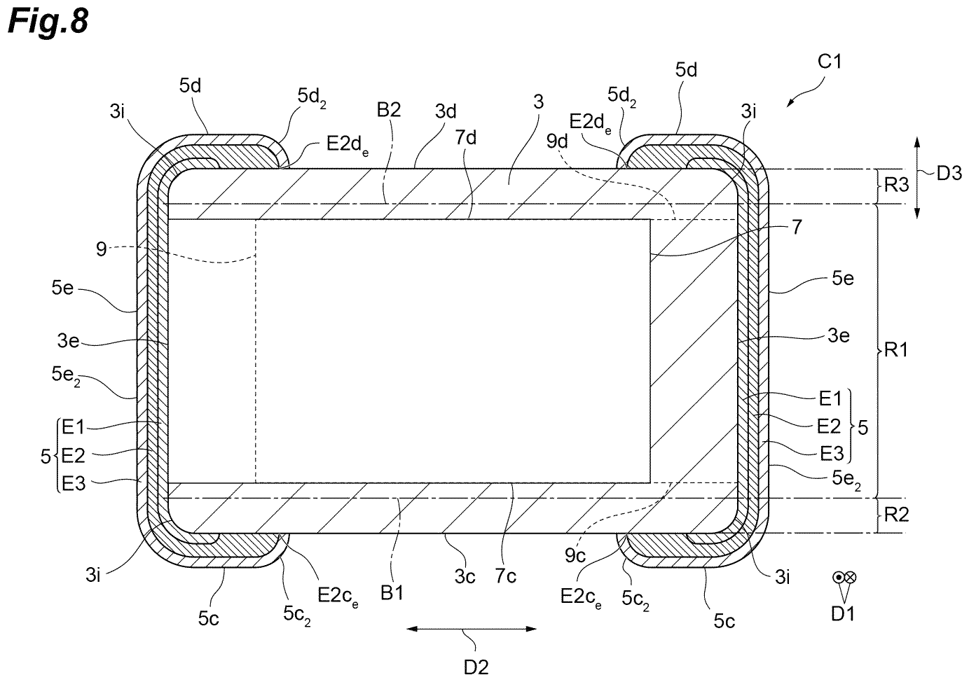

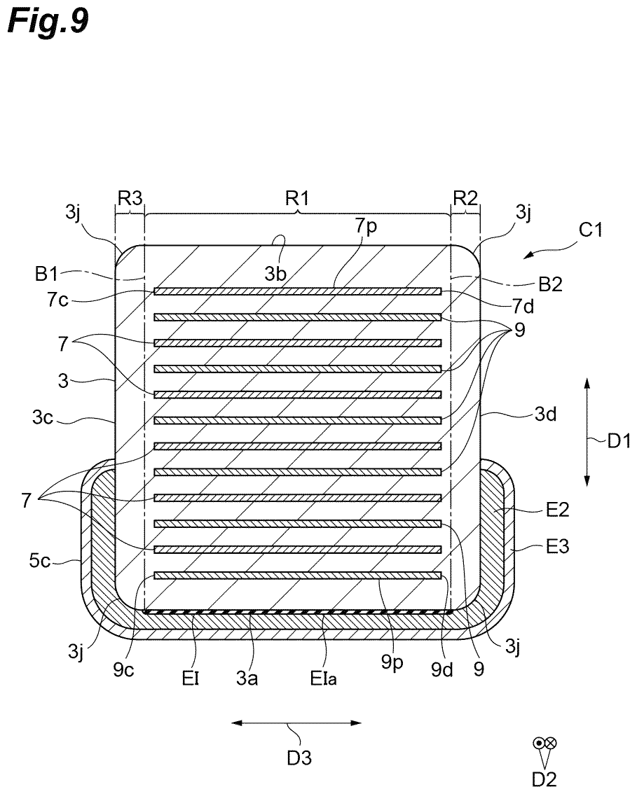

A configuration of a multilayer capacitor C1 according to a modified example of the first example will be described with reference to FIGS. 7 to 9. FIGS. 7, 8, and 9 are views illustrating a cross-sectional configuration of an electronic component according to a modified example of the first example. The multilayer capacitor C1 according to this modified example is generally similar to or the same as the multilayer capacitor C1 according to the first example. However, the multilayer capacitor C1 according to this modified example is different from the multilayer capacitor C1 according to the first example in the regions R1, R2, and R3 included in the element body 3. Hereinafter, differences between the above-described first example and this modified example will be mainly described.

As with the multilayer capacitor C1 according to the first example, the multilayer capacitor C1 according to the modified example includes an element body 3 of a rectangular parallelepiped shape, a pair of external electrodes 5, a plurality of internal electrodes 7, a plurality of internal electrodes 9, and an electrical insulation film EI. The element body 3 includes regions R1, R2, and R3. The plurality of internal electrodes 7 and the plurality of internal electrodes 9 are disposed in the region R1. Each of the plurality of internal electrodes 7 and 9 is electrically connected to a corresponding external electrode 5 of the pair of external electrodes 5.

A length in the third direction D3 of each of the regions R1, R2, and R3 according to the modified example differ from the length in the third direction D3 of each of the regions R1, R2, and R3 according to the first example. The length in the third direction D3 of the region R2 according to the modified example is smaller than the length in the third direction D3 of the region R2 according to the first example. The length in the third direction D3 of the region R3 according to the modified example is smaller than the length in the third direction D3 of the region R2 according to the first example. The length in the third direction D3 of the region R1 according to the modified example is larger than the length in the third direction D3 of the region R1 according to the first example by an amount corresponding to a decrease in the length of each of the regions R2 and R3.

Each of the plurality of internal electrodes 7 and 9 is positioned in the region R1, away from the end B1. The end 7c of each of the plurality of internal electrodes 7 extends in the second direction D2 in the region R1, away from the end B1. The end 9c of each of the plurality of internal electrodes 9 extends in the second direction D2 in the region R1, away from the end B1. Each of the plurality of internal electrodes 7 and 9 is positioned in the region R1, away from the end B2. The end 7d of each of the plurality of internal electrodes 7 extends in the second direction D2 in the region R1, away from the end B2. The end 9d of each of the plurality of internal electrodes 9 extends in the second direction D2 in the region R1, away from the end B2. The plurality of internal electrodes 7 and 9 are not disposed in the regions R2 and R3.

In the multilayer capacitor C1, each of the plurality of internal electrodes 7 and 9 is positioned in the region R1, away from the end B1 opposing the side surface 3c.

In the multilayer capacitor C1, the plurality of internal electrodes 7 and 9 are reliably positioned in the region R1. Therefore, the multilayer capacitor C1 prevents a decrease in capacitance.

In the multilayer capacitor C1, each of the plurality of internal electrodes 7 and 9 is positioned in the region R1, away from the end B2 opposing the side surface 3d.

In the multilayer capacitor C1, the plurality of internal electrodes 7 and 9 are reliably positioned in the region R1. Therefore, the multilayer capacitor C1 prevents a decrease in capacitance.

### Second Example

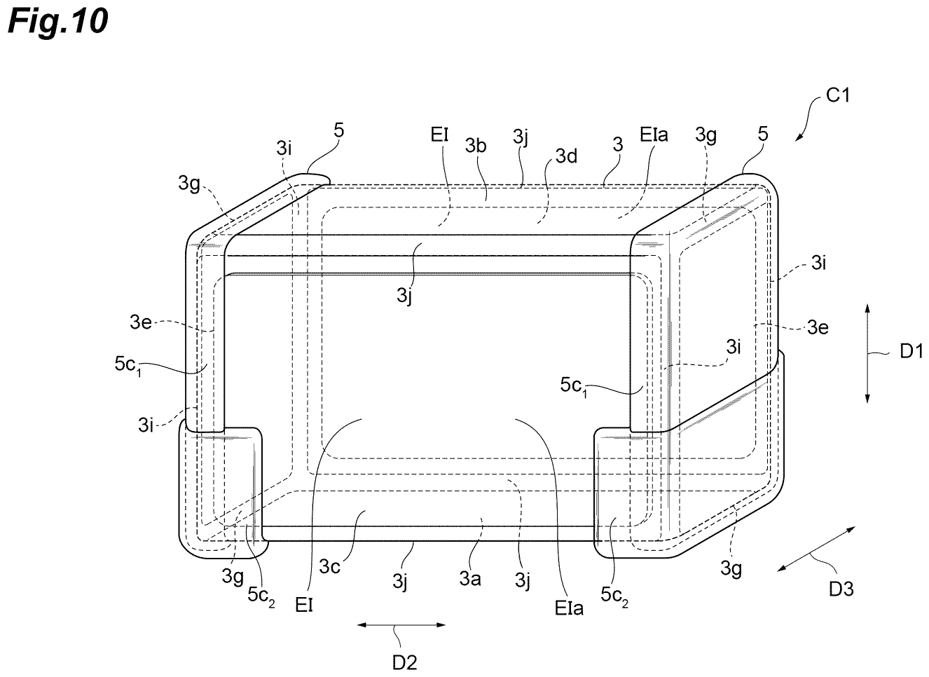

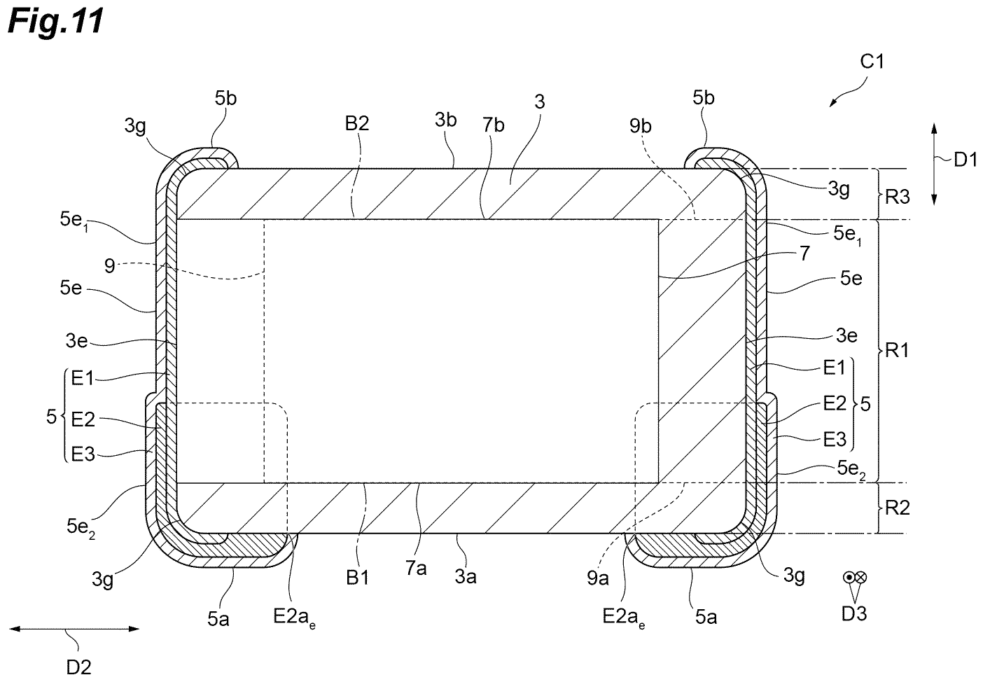

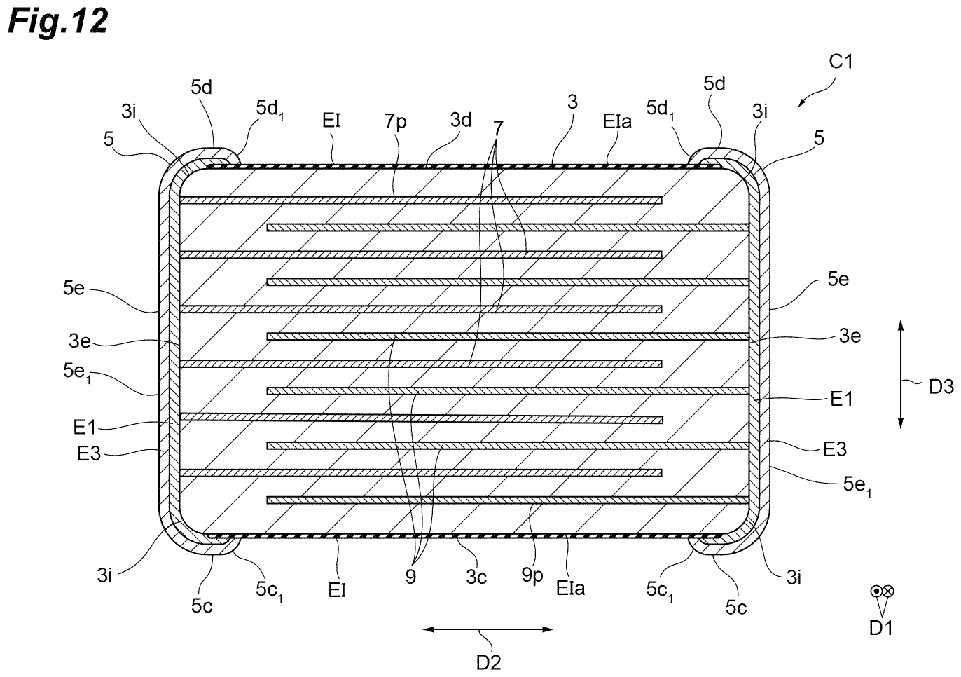

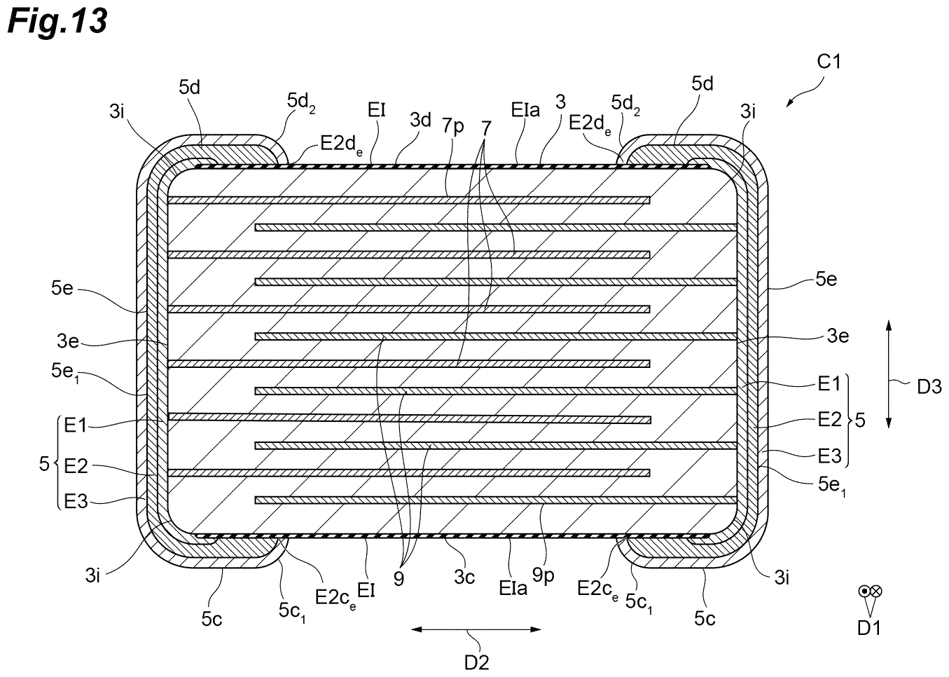

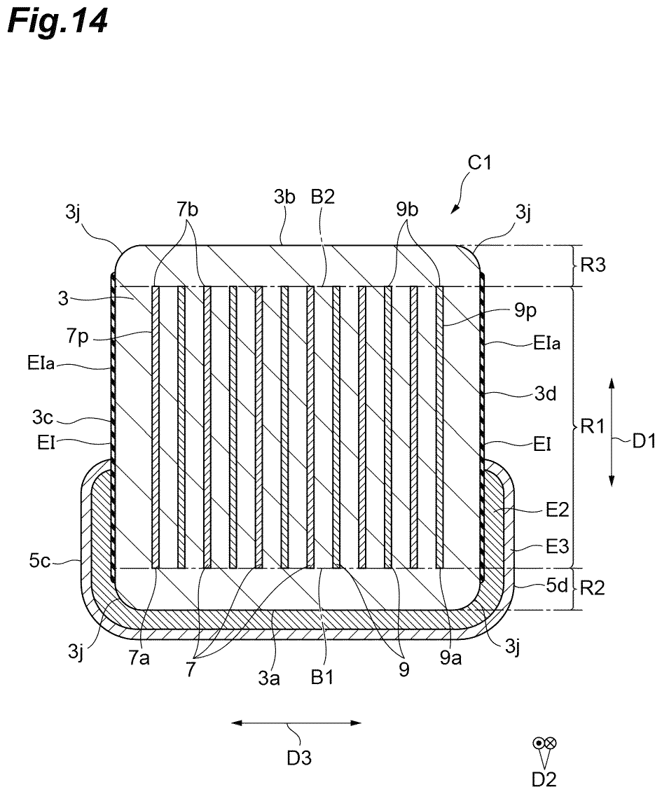

A configuration of a multilayer capacitor C1 according to a second example will be described with reference to FIGS. 10 to 14. FIG. 10 is a perspective view of an electronic component according to the second example. FIGS. 11, 12, 13, and 14 are views illustrating a cross-sectional configuration of the electronic component according to the second example. The multilayer capacitor C1 according to the second example is generally similar to or the same as the multilayer capacitor C1 according to the first example. However, the multilayer capacitor C1 according to the second example is different from the multilayer capacitor C1 according to the first example in the regions R1, R2, and R3 included in the element body 3, the plurality of internal electrodes 7 and 9, and the electrical insulation film EI. Hereinafter, differences between the above-described first example and the second example will be mainly described.

As with the multilayer capacitor C1 according to the first example, the multilayer capacitor C1 according to the second example includes an element body 3 of a rectangular parallelepiped shape, a pair of external electrodes 5, a plurality of internal electrodes 7, a plurality of internal electrodes 9, and an electrical insulation film EI, as illustrated in FIGS. 10 to 14. The side surface 3a is arranged to constitute a mounting surface. The side surface 3a includes the mounting surface. For example, when the side surface 3a includes a first side surface, the side surface 3b includes a third side surface. For example, when the side surface 3c includes a second side surface, the side surface 3d includes a fourth side surface.

The element body 3 includes a region R1, a region R2, and a region R3. The region R1 does not include the side surface 3a and the side surface 3b. The region R2 includes the side surface 3a. The region R2 includes, for example, the entirety of the side surface 3a. The region R3 includes the side surface 3b. The region R3 includes, for example, the entirety of the side surface 3b. The region R1 is positioned between the region R2 and the region R3 in the first direction D1. The region R1 is positioned away from the side surface 3a and the side surface 3b.

A height of the region R2 is equal to a height of the region R3. The height of the region R2 is a length in the third direction D3 of the region R2. The height of the region R3 is a length in the third direction D3 of the region R3. A width of the region R2 is equal to a width of the region R3. The width of the region R2 is a length in the second direction D2 of the region R2. The width of the region R3 is a length in the second direction D2 of the region R3. A thickness of the region R2 is equal to a thickness of the region R3. The thickness of the region R2 is a length in the first direction D1 of the region R2. The thickness of the region R3 is a length in the first direction D1 of the region R3. The thickness of the region R2 may not be equal to the thickness of the region R3. The thickness of the region R2 may be different from the thickness of the region R3. The region R2 and the region R3 have a dielectric constant smaller than a dielectric constant of the region R1. The region R2 and the region R3 have a surface resistivity larger than a surface resistivity of the region R1. The side surface 3a and the side surface 3b have a surface resistivity larger than the surface resistivity of the side surfaces 3c and 3d.

The second electrode layer E2 continuously covers a part of the side surface 3c, a part of the side surface 3a, a part of the side surface 3d, and a part of a corresponding end surface 3e of the pair of end surfaces 3e. The second electrode layer E2, for example, continuously covers only a part of each of the side surfaces 3c and 3d, only a part of the side surface 3a, and only a part of the corresponding end surface 3e. The second electrode layer E2 includes a portion that is positioned to continuously cover only a part of each of the side surfaces 3c and 3d, only a part of the side surface 3a, and only a part of the corresponding end surface 3e. The above-described part of the end surface 3e includes a portion, of the end surface 3e, closer to the side surface 3a. The above-mentioned part of the side surface 3c includes a portion, of the side surface 3c, closer to the side surface 3a, and the above-mentioned part of the side surface 3d includes a portion, of the side surface 3d, closer to the side surface 3a. The second electrode layer E2 covers the entirety of the one ridge portion 3g, only a part of the ridge portion 3i, and only a part of the ridge portion 3j. A part of the portion that is included in the first electrode layer E1 and covers the ridge portion 3i is exposed from the second electrode layer E2. For example, the first electrode layer E1 included in each of the regions 5c₁, 5d₁, and 5e₁ is exposed from the second electrode layer E2. The second electrode layer E2 includes a conductive resin layer.

The internal electrode 7 and the internal electrode 9 are disposed in different positions (layers) in the first direction D3. For example, the internal electrode 7 and the internal electrode 9 oppose each other in a direction orthogonal to both the direction in which the pair of end surfaces 3e oppose each other and the direction in which the side surface 3a and the side surface 3b oppose each other. The direction in which the pair of end surfaces 3e oppose each other may include the second direction D2. The direction in which the side surface 3a and the side surface 3b oppose each other may include the first direction D1. The direction orthogonal to both the direction in which the pair of end surfaces 3e oppose each other and the direction in which the side surface 3a and the side surface 3b oppose each other may include the third direction D3. The internal electrodes 7 and the internal electrodes 9 are alternately disposed in the element body 3 to oppose each other in the third direction D3 with an interval therebetween. Each internal electrode 7 and 9 is positioned in a plane substantially parallel to the side surfaces 3c and 3d.

Each of the plurality of internal electrodes 7 and 9 includes one end exposed to a corresponding end surface 3e of the pair of end surfaces 3e. The above-described one end included in each of the plurality of internal electrodes 7 and 9 is covered by a corresponding electrode portion 5e of the plurality of electrode portions 5e. For example, the above-described one end is entirely covered with the corresponding electrode portion 5e. The internal electrode 7 and the internal electrode 9 are directly connected to the corresponding electrode portion 5e. The internal electrode 7 and the internal electrode 9 are electrically connected to a corresponding external electrode 5 of the plurality of external electrodes 5. Each of the plurality of internal electrodes 7 includes an end 7a closer to the side surface 3a and an end 7b closer to the side surface 3b. Each of the plurality of internal electrodes 9 includes an end 9a closer to the side surface 3a and an end 9b closer to the side surface 3b. The ends 7a and 7b, and the ends 9a and 9b are not exposed to an outer surface of the element body 3

The plurality of internal electrodes 7 and 9 are disposed in the region R1. The end 7a included in each of the plurality of internal electrodes 7 extends in the second direction D2 along an end B1, of the in region R1, opposing the side surface 3a. The end 9a included in each of the plurality of internal electrodes 9 extends in the second direction D2 along the end B1. The end 7b included in each of the plurality of internal electrodes 7 extends in the second direction D2 along an end B2, of the region R1, opposing the side surface 3b. The end 9b included in each of the plurality of internal electrodes 9 extends in the second direction D2 along the end B2. For example, when viewed from the second direction D2, the ends 7a and 9a correspond to the end B1, and the ends 7b and 9b correspond to the end B2. The plurality of internal electrodes 7 and 9 are not disposed in the region R2 and the region R3.

Each of the plurality of internal electrodes 7 and 9 may be positioned in the region R1, away from the end B1. The end 7a of each of the plurality of internal electrodes 7 may extend in the second direction D2 in the region R1, away from the end B1. The end 9a of each of the plurality of internal electrodes 9 may extend in the second direction D2 in the region R1, away from the end B1. Each of the plurality of internal electrodes 7 and 9 may be positioned in the region R1, away from the end B2. The end 7b of each of the plurality of internal electrodes 7 may extend in the second direction D2 in the region R1, away from the end B2. The end 9b of each of the plurality of internal electrodes 9 may extend in the second direction D2 in the region R1, away from the end B2. In these cases, the lengths of the regions R2 and R3 in the first direction D1 decrease, and the length of the region R1 in the first direction D1 is larger by an amount corresponding to a decrease in the length of each of the regions R2 and R3 in the first direction D1. The plurality of internal electrodes 7 and 9 are not disposed in the regions R2 and R3.

The plurality of internal electrodes 7 includes an outermost internal electrode 7p adjacent to the side surface 3d. When the outermost internal electrode 7p and the second electrode layer E2 that is not electrically connected to the outermost internal electrode 7p are viewed in a direction orthogonal to the side surface 3d, that is, in the third direction D3, the outermost internal electrode 7p overlaps with the second electrode layer E2 that is not electrically connected to the outermost internal electrode 7p.

The plurality of internal electrodes 9 includes an outermost internal electrode 9p adjacent to the side surface 3c. When the outermost internal electrode 9p and the second electrode layer E2 that is not electrically connected to the outermost internal electrode 9p are viewed in a direction orthogonal to the side surface 3c, that is, in the third direction D3, the outermost internal electrode 9p overlaps with the second electrode layer E2 that is not electrically connected to the outermost internal electrode 9p. For example, when the outermost internal electrode 7p includes the second outermost internal electrode, the outermost internal electrode 9p includes the first outermost internal electrode.

The electrical insulation film EI is positioned on both the side surface 3c and the side surface 3d. The film portion EIa is at least positioned on a region, of the side surface 3c, between the plurality of external electrodes 5, and is at least positioned on a region, of the side surface 3d, between the plurality of external electrodes 5. The film portion EIa covers the side surface 3c and is directly in contact with the side surface 3c. The film portion EIa covers the side surface 3d and is directly in contact with the side surface 3d. The film portion EIa is positioned only on both the side surface 3c and the side surface 3d.

Each end surface 3e is exposed from the electrical insulation film EI (film portion EIa). Therefore, the above-described one end included in each of the plurality of internal electrodes 7 and 9 includes a region exposed from the electrical insulation film EI. For example, the above-described one end included in each of the plurality of internal electrodes 7 and 9 includes only the region exposed from the electrical insulation film EI. The entirety of the above-described one end included in each of the plurality of internal electrodes 7 and 9 is exposed from the electrical insulation film EI. The side surfaces 3a and 3b, and the ridge portions 3g, 3i, and 3j are exposed from the electrical insulation film EI. The electrical insulation film EI (film portion EIa) opposes the plurality of internal electrodes 7 and 9 in the third direction D3.

In the multilayer capacitor C1 according to the second example, the element body 3 includes the side surface 3d opposing the side surface 3c, and the side surface 3b opposing the side surface 3a, and includes the region R3 including the side surface 3d and having the dielectric constant smaller than the dielectric constant of the region R1. The second electrode layer E2 is positioned on the side surface 3d. The electrical insulation film EI includes the film portion EIa positioned on a region, of the side surface 3b, between the second electrode layer E2.

In the multilayer capacitor C1 according to the second example, even when a metal particle included in the second electrode layer E2 positioned on the side surface 3d ionize, the film portion EIa prevents a generated metal ion from reacting with an electron resulting from a leakage current. The electron tends not to be supplied to the metal ion. A metal tends not to be deposited on the side surface 3d. Therefore, a configuration in which the electrical insulation film EI includes the film portion EIa that is positioned on the region, of the side surface 3d, between the second electrode layers E2 reduces occurrence of migration even in a configuration in which the external electrode 5 includes the second electrode layer E2 positioned on the side surface 3d.

In the multilayer capacitor C1 according to the second example, the electrical insulation film EI is positioned only on the side surface 3c and the side surface 3d. The electrical insulation film EI can be easily formed, for example, as compared with a configuration in which the electrical insulation film EI is disposed on the side surface 3a, the side surface 3b, the side surface 3c and the side surface 3d.

In the multilayer capacitor C1 according to the second example, the plurality of internal electrodes 7 and 9 oppose each other in the direction in which the side surface 3c and the side surface 3d oppose each other.

In the multilayer capacitor C1 according to the second example, an electron tends to be supplied as a leakage current from at least one of the internal electrodes 7 and 9 to the second electrode layer E2 positioned on both the side surface 3c and the side surface 3d. However, as described above, the film portion EIa prevents the generated metal ion from reacting with the electron. Therefore, in the multilayer capacitor C1 according to the second example, the occurrence of the migration is reliably prevented.

In the multilayer capacitor C1 according to the second example, the plurality of internal electrodes 7 and 9 include the outermost internal electrode 9p adjacent to the side surface 3c and the outermost internal electrode 7p adjacent to the side surface 3d. When the outermost internal electrode 9p and the second electrode layer E2 that is not electrically connected to the outermost internal electrode 9p are viewed in the direction orthogonal to the side surface 3c, the outermost internal electrode 9p overlaps with the second electrode layer E2 that is not electrically connected to the outermost internal electrode 9p. When the outermost internal electrode 7p and the second electrode layer E2 that is not electrically connected to the outermost internal electrode 7p are viewed in the direction orthogonal to the side surface 3d, the outermost internal electrode 7p overlaps with the second electrode layer E2 that is not electrically connected to the outermost internal electrode 7p.

In the multilayer capacitor C1 according to the second example, an electron tends to be supplied as a leakage current from the outermost internal electrode 9p to the second electrode layer E2 positioned on the side surface 3c. However, as described above, the film portion EIa prevents the generated metal ion from reacting with the electron resulting from the leakage current. A metal tends not to be deposited on the side surface 3c.

In the multilayer capacitor C1 according to the second example, an electron tends to be supplied as a leakage current from the outermost internal electrode 7p to the second electrode layer E2 positioned on the side surface 3d. However, as described above, the film portion EIa prevents the generated metal ion from reacting with the electron resulting from the leakage current. A metal tends not to be deposited on the side surface 3d.

Therefore, in the multilayer capacitor C1 according to the second example, the occurrence of the migration is reliably prevented.

The multilayer capacitor C1 according to the second example can increase lengths of the plurality of internal electrodes 7 and 9 in the direction in which the pair of end surfaces 3e opposing each other. Therefore, the multilayer capacitor C1 according to the second example can increase capacitance.

In the multilayer capacitor C1 according to the second example, the second electrode layer E2 continuously covers a part of the side surface 3a, a part of the side surface 3c, a part of the side surface 3d, and a part of the corresponding end surface 3e of the pair of end surfaces 3e.

The multilayer capacitor C1 according to the second example tends to lead to a decrease in the amount of conductive resin paste used to form the second electrode layer E2, as compared with a configuration in which the second electrode layer E2 continuously covers a part of the side surface 3a, a part of the side surface 3c, a part of the side surface 3d, and the entire corresponding end surface 3e. The decrease in the amount of the conductive resin paste tends to lead to a decrease in a length of the second electrode layer E2 in the direction in which the pair of end surfaces 3e oppose each other and an increase in a distance between the pair of external electrodes 5 on the side surfaces 3a, 3c, and 3d. The increase in the distance between the pair of external electrodes 5 reduces an electric field between the pair of external electrodes 5. Therefore, the generated metal ion tends not to migrate from the second electrode layer E2. Consequently, the multilayer capacitor C1 according to the second example can further prevent the occurrence of the migration.

The multilayer capacitor C1 according to the second example reduces ESR, as compared with a configuration in which the second electrode layer E2 continuously covers a part of the side surface 3a, a part of the side surface 3c, a part of the side surface 3d, and the entire corresponding end surface 3e.

### Third Example

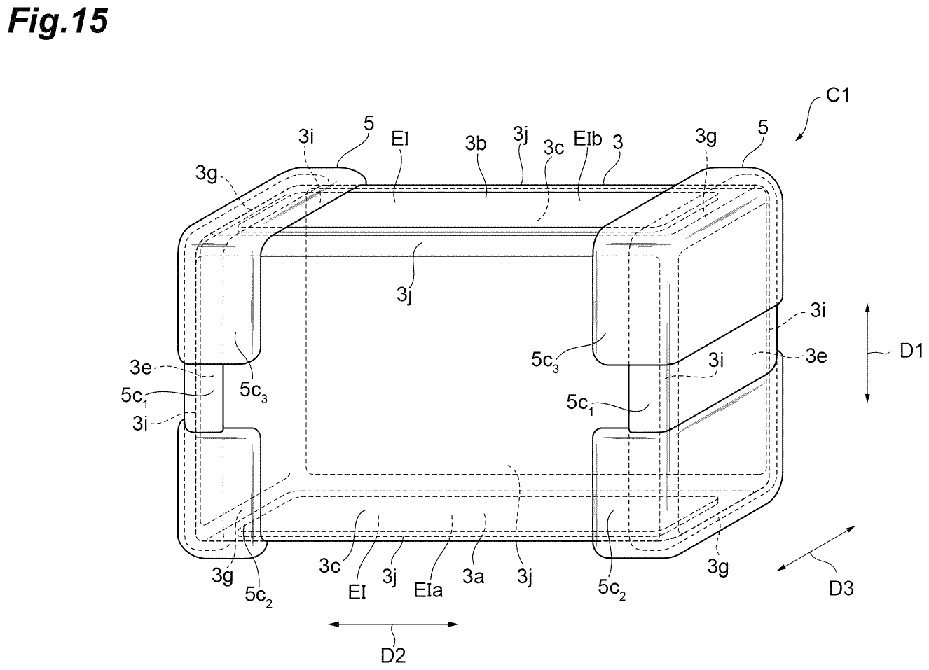

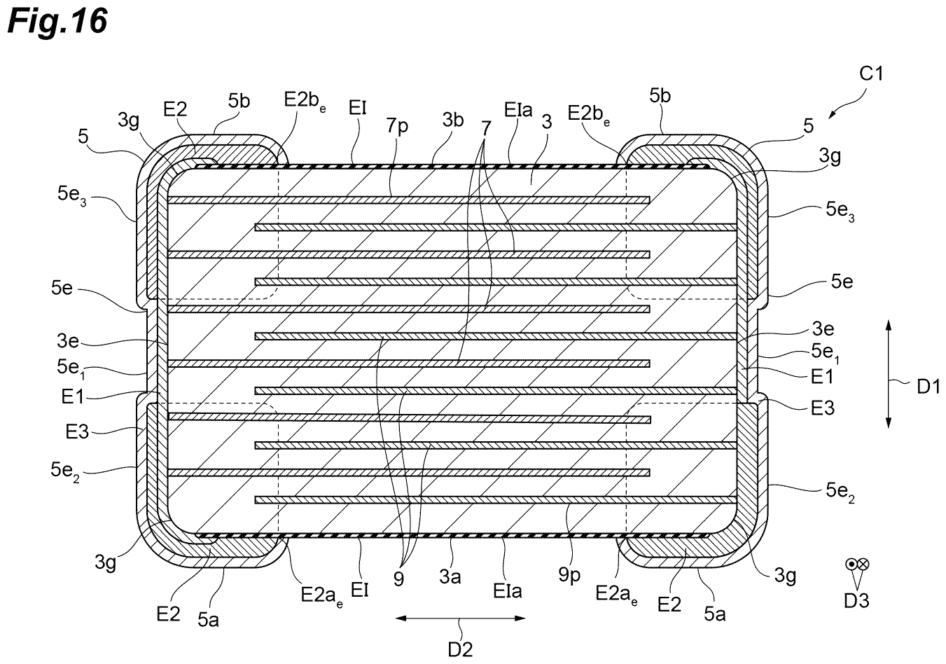

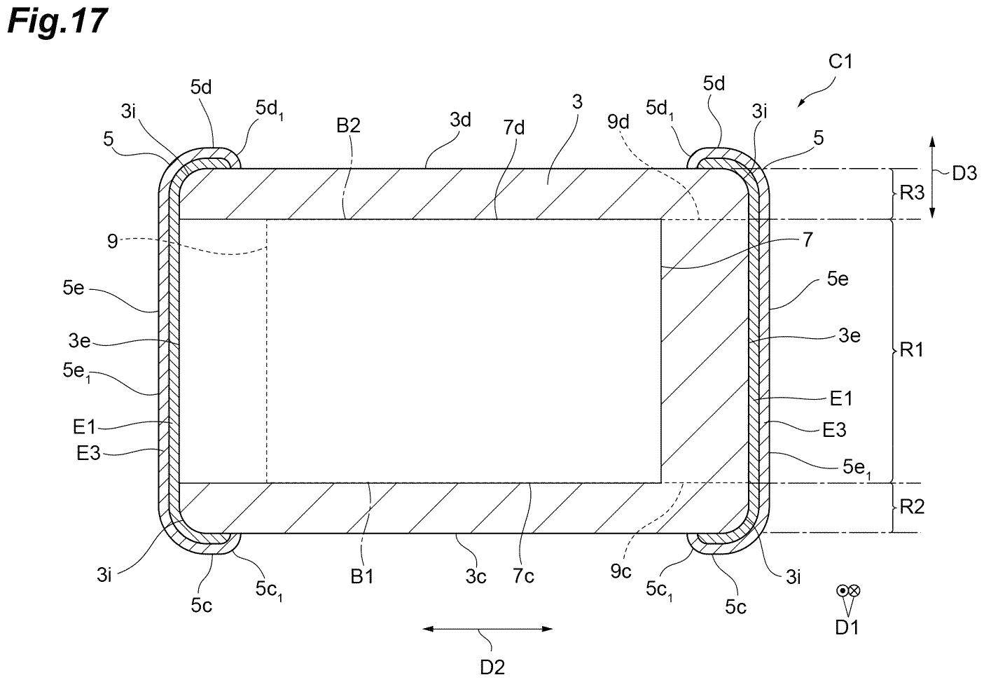

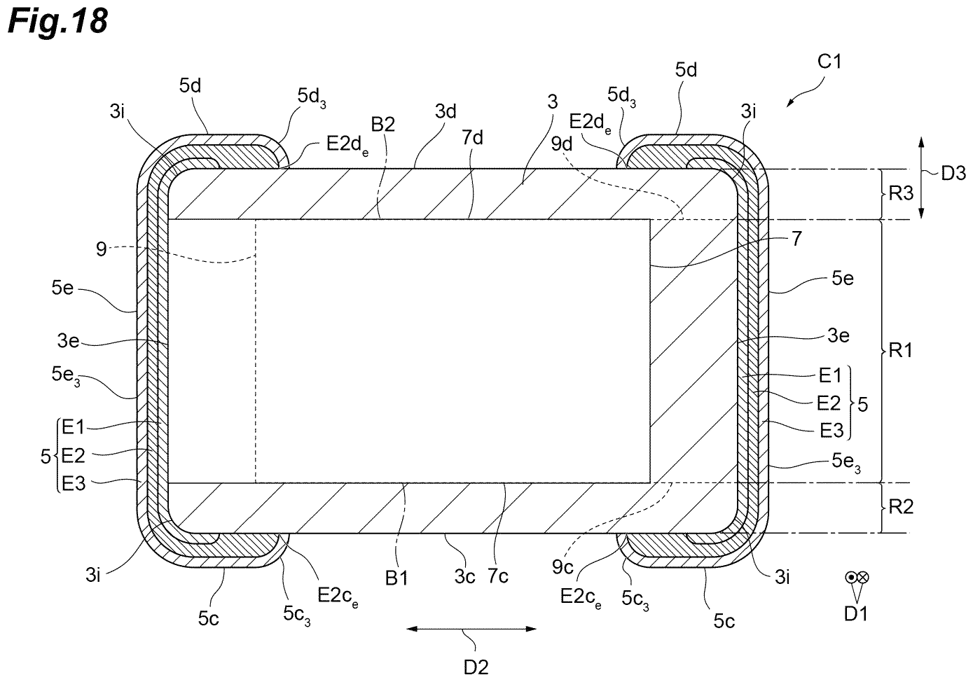

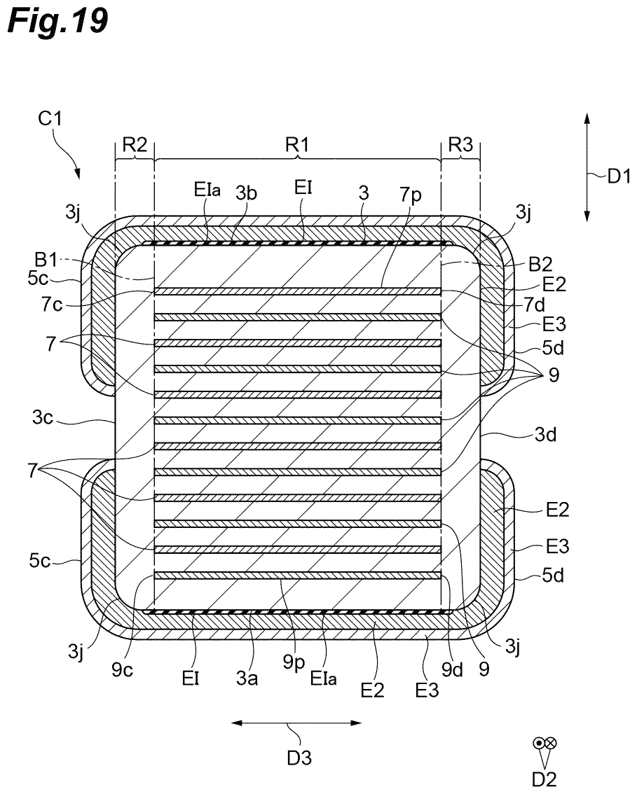

A configuration of a multilayer capacitor C1 according to a third example will be described with reference to FIGS. 15 to 19. FIG. 15 is a perspective view of an electronic component according to the third example. FIGS. 16, 17, 18, and 19 are views illustrating a cross-sectional configuration of the electronic component according to the third example. The multilayer capacitor C1 according to the third example is generally similar to or the same as the multilayer capacitor C1 according to the first example. However, the multilayer capacitor C1 according to the third example is different from the multilayer capacitor C1 according to the first example in the external electrodes 5 and the electrical insulation film EI. Hereinafter, differences between the above-described first example and the third example will be mainly described.

As with the multilayer capacitor C1 according to the first example, the multilayer capacitor C1 according to the third example includes an element body 3 of a rectangular parallelepiped shape, a pair of external electrodes 5, a plurality of internal electrodes 7, a plurality of internal electrodes 9, and an electrical insulation film EI. The side surface 3a is arranged to constitute a mounting surface. The side surface 3a includes the mounting surface. Each of the pair of external electrodes 5 includes a second electrode layer E2 positioned on the side surface 3c and the side surface 3a. The electrical insulation film EI includes a film portion EIa positioned on a region, of the side surface 3a, between the second electrode layers E2. Each of the pair of external electrodes 5 includes a second electrode layer E2 positioned on the side surface 3c and the side surface 3b. The electrical insulation film EI includes a film portion EIa positioned on the region, of the side surface 3b, between the second electrode layers E2. For example, when the side surface 3a includes the second side surface, the side surface 3b includes the fourth side surface. For example, when the side surface 3c includes the first side surface, the side surface 3d includes the third side surface.

Each external electrode 5 includes the plurality of electrode portions 5a, 5b, 5c, 5d, and 5e. Each of the electrode portions 5a, 5b, 5c, 5d, and 5e includes the first electrode layer E1, the second electrode layer E2, and the third electrode layer E3. The second electrode layer E2 includes a conductive resin layer.

The second electrode layer E2 of the electrode portion 5b is positioned on both the first electrode layer E1 and the electrical insulation film EI. In the electrode portion 5b, the second electrode layer E2 is formed on the first electrode layer E1 to cover the first electrode layer E1 of the electrode portion 5b, and is formed on the electrical insulation film EI to cover a part of the electrical insulation film EI. The second electrode layer E2 of the electrode portion 5b is in contact with the above-described part of the electrical insulation film EI and the entirety of the first electrode layer E1 of the electrode portion 5b. In the electrode portion 5b, the second electrode layer E2 is directly in contact with the first electrode layer E1 and the electrical insulation film EI. In the electrode portion 5b, the second electrode layer E2 indirectly covers the side surface 3b such that the first electrode layer E1 is positioned between the second electrode layer E2 and the side surface 3b. The second electrode layer E2 of the electrode portion 5b is positioned on the side surface 3b. The second electrode layer E2 of the electrode portion 5b includes an end edge E2bₑ positioned on the side surface 3b.

The third electrode layer E3 of the electrode portion 5b is positioned on the second electrode layer E2. In the electrode portion 5b, the third electrode layer E3 covers the second electrode layer E2. In the electrode portion 5b, the third electrode layer E3 is in contact with the second electrode layer E2. In the electrode portion 5b, the third electrode layer E3 is directly in contact with the second electrode layer E2. In the electrode portion 5b, the third electrode layer E3 is not directly in contact with the first electrode layer E1. The third electrode layer E3 of the electrode portion 5b is positioned on the side surface 3b.

In the electrode section 5c, the second electrode layer E2 is formed to cover the above-described part of the first electrode layer E1 and the above-described part of the side surface 3c, and to cover another part of the first electrode layer E1 and another part of the side surface 3c. In the electrode section 5c, the second electrode layer E2 is directly in contact with the above-described another part of the first electrode layer E1 and the above-described another part of the side surface 3c. The second electrode layer E2 of the electrode section 5c covers the above-described another part of the first electrode layer E1 of the electrode section 5c. For example, one region included in the side surface 3c and covered with the second electrode layer E2 is positioned closer to the side surface 3a and the end surface 3e, and another region included in the side surface 3c and covered with the second electrode layer E2 is positioned closer to the side surface 3b and the end surface 3e. In the electrode section 5c, the second electrode layer E2 indirectly covers the above-described another part of the side surface 3c such that the first electrode layer E1 is positioned between the second electrode layer E2 and the side surface 3c. The first electrode layer E1 of the electrode section 5c is covered with the second electrode layer E2 in the above-described part and the above-described another part, and is exposed from the second electrode layer E2 in the remaining part excluding the above-described part and the above-described another part.

The electrode section 5c includes a plurality of regions 5c1, 5c2, and 5c3. For example, the electrode section 5c includes only three regions 5c1, 5c2, and 5c3. The region 5c3 is positioned closer to the side surface 3b than the region 501. The region 5c3 includes the first electrode layer E1, the second electrode layer E2, and the third electrode layer E3. The region 5c3 includes a region in which the first electrode layer E1 is covered with the second electrode layer E2. In the first direction D1, the region 5c1 is positioned between the region 5c2 and the region 5c3.

In the electrode section 5d, the second electrode layer E2 is formed to cover the above-described part of the first electrode layer E1 and the above-described part of the side surface 3d, and to cover another part of the first electrode layer E1 and another part of the side surface 3d. In the electrode section 5d, the second electrode layer E2 is directly in contact with the above-described another part of the first electrode layer E1 and the above-described another part of the side surface 3d. The second electrode layer E2 of the electrode section 5d covers the above-described another part of the first electrode layer E1 of the electrode section 5d. For example, one region included in the side surface 3d and covered with the second electrode layer E2 is positioned closer to the side surface 3a and the end surface 3e, and another region included in the side surface 3d and covered with the second electrode layer E2 is positioned closer to the side surface 3b and the end surface 3e. In the electrode section 5d, the second electrode layer E2 indirectly covers the above-described another part of the side surface 3d such that the first electrode layer E1 is positioned between the second electrode layer E2 and the side surface 3d. The first electrode layer E1 of the electrode section 5d is covered with the second electrode layer E2 in the above-described part and the above-described another part, and is exposed from the second electrode layer E2 in the remaining part excluding the above-described part and the above-described another part.

The electrode section 5d includes a plurality of regions 5d1, 5d2, and 5d3. For example, the electrode section 5d includes only three regions 5d1, 5d2, and 5d3. The region 5d3 is positioned closer to the side surface 3b than the region 5d1. The region 5d3 includes the first electrode layer E1, the second electrode layer E2, and the third electrode layer E3. The region 5d3 includes a region in which the first electrode layer E1 is covered with the second electrode layer E2. In the first direction D1, the region 5d1 is positioned between the region 5d2 and the region 5d3.

In the electrode portion 5e, the second electrode layer E2 is formed to cover the above-described part of the first electrode layer E1 and another part of the first electrode layer E1. In the electrode portion 5e, the second electrode layer E2 is directly in contact with the above-described another part of the first electrode layer E1. The second electrode layer E2 of the electrode portion 5e covers the above-described another part of the first electrode layer E1 of the electrode portion 5e. In the electrode portion 5e, the second electrode layer E2 indirectly covers another part of the end surface 3e such that the first electrode layer E1 is positioned between the second electrode layer E2 and the end surface 3e. For example, the above-described another part of the end surface 3e is positioned closer to the side surface 3b, in the end surface 3e. The first electrode layer E1 of the electrode portion 5e is covered with the second electrode layer E2 in the above-described part and the above-described another part, and is exposed from the second electrode layer E2 in the remaining portion excluding the above-described part and the above-described another part.

The electrode section 5e includes a plurality of regions 5e₁, 5e₂, and 5e₃. For example, the electrode section 5e includes only three regions 5e₁, 5e₂, and 5e₃. The region 5e₃ is positioned closer to the side surface 3b than the region 5e₁. The region 5e₃ includes the first electrode layer E1, the second electrode layer E2, and the third electrode layer E3. The region 5e₃ includes a region in which the first electrode layer E1 is covered with the second electrode layer E2. In the first direction D1, the region 5e₁ is positioned between the region 5e₂ and the region 5e₃.

In the multilayer capacitor C1 according to the third example, the second electrode layer E2 continuously covers, for example, only a part of the side surface 3a, only one part of the end surface 3e, only one part of each of the side surface 3c and 3d, and continuously covers, for example, only a part of the side surface 3b, only another part of the end surface 3e, only another part of each of the side surface 3c and 3d. The second electrode layer E2 includes a plurality of portion away from each other. The second electrode layer E2 includes a first portion that is positioned to continuously cover only a part of the side surface 3a, only one part of the end surface 3e, and only one part of each of the side surfaces 3c and 3d, and a second portion that is positioned to continuously cover only a part of the side surface 3b, only another part of the end surface 3e, and only another part of each of the side surfaces 3c and 3d.

The above-described one part of the end surface 3e is positioned closer to the side surface 3a. The above-described one part of each of the side surfaces 3c and 3d is positioned closer to the side surface 3a. The above-described another part of the end surface 3e is positioned closer to the side surface 3b. The above-described another part of each of the side surfaces 3c and 3d is positioned closer to the side surface 3b. The second electrode layer E2 covers the entirety of one ridge portion 3g, only one part of the ridge portion 3i, and only a part of the ridge portion 3j, and covers the entirety of another ridge portion 3g, only another part of the ridge portion 3i, and only another part of the ridge portion 3j.

A part of a portion, of the first electrode layer E1, covering the ridge portion 3i is exposed from the second electrode layer E2. For example, the first electrode layer E1 included in each of the regions 5c₁, 5d₁, and 5e₁ is exposed from the second electrode layer E2.

In a configuration in which the electrode portion 5e does not include the second electrode layer E2, the second electrode layer E2 continuously covers only a part of each of the side surfaces 3c and 3d and only a part of the end surface 3e.

The film portions Ela are at least positioned on regions, of the side surfaces 3a and 3b, between the plurality of external electrodes 5. The side surfaces 3c and 3d, the pair of end surfaces 3e, and each of the ridge portions 3g, 3i, and 3j are exposed from the electrical insulation film EI. The electrical insulation film EI includes the film portion EIa positioned on the region, of each of the side surfaces 3a and 3b, between the plurality of second electrode layers E2.

The plurality of internal electrodes 7 and the plurality of internal electrodes 9 are alternately disposed in the first direction D1. The plurality of internal electrodes 7 includes an outermost internal electrode 7p adjacent to the side surface 3b. When the outermost internal electrode 7p and the second electrode layer E2 that is not electrically connected to the outermost internal electrode 7p are viewed in a direction perpendicular to the side surface 3c, that is, in the third direction D3, the outermost internal electrode 7p overlaps with the second electrode layer E2 that is not electrically connected to the outermost internal electrode 7p.

The plurality of internal electrodes 9 includes an outermost internal electrode 9p adjacent to the side surface 3a. When the outermost internal electrode 9p and the second electrode layer E2 that is not electrically connected to the outermost internal electrode 9p are viewed in the direction perpendicular to the side surface 3c, that is, in the third direction D3, the outermost internal electrode 9p overlaps with the second electrode layer E2 that is not electrically connected to the outermost internal electrode 9p.

For example, the plurality of internal electrodes 7 and the plurality of internal electrodes 9 may be alternately disposed in the third direction D3.

In the multilayer capacitor C1 according to the third example, the element body 3 includes the side surface 3b opposing the side surface 3a. The second electrode layer E2 is positioned on the side surface 3b. The electrical insulation film EI includes the film portion EIa positioned on the region, of the side surface 3b, between the second electrode layer E2.

In the multilayer capacitor C1 according to the third example, the region R2 including the side surface 3c has a dielectric constant smaller than a dielectric constant of the region R1. Therefore, the multilayer capacitor C1 according to the third example prevents occurrence of a leakage current in the region R2. Even when a metal particle included in the second electrode layer E2 positioned on the side surface 3c ionize, an electron tends not to be supplied to a metal ion. A metal tends not to be deposited on the side surface 3c.

In the multilayer capacitor C1 according to the third example, the region R3 including the side surface 3d has a dielectric constant smaller than a dielectric constant of the region R1. Therefore, the multilayer capacitor C1 according to the third example prevents occurrence of a leakage current in the region R3. Even when a metal particle included in the second electrode layer E2 positioned on the side surface 3d ionize, an electron tends not to be supplied to a metal ion. A metal tends not to be deposited on the side surface 3d.

In the multilayer capacitor C1 according to the third example, the film portion EIa included in the electrical insulation film EI is positioned on the regions, of the side surfaces 3a and 3b, between the second electrode layers E2. Therefore, even when a metal particle included in the second electrode layer E2 positioned on the side surfaces 3a and 3b ionize, the film portions Ela prevent a generated metal ion from reacting with an electron resulting from a leakage current. The electron tends not to be supplied to the metal ion. A metal tends not to be deposited on the side surfaces 3a and 3b.

Consequently, the multilayer capacitor C1 according to the third example reduces occurrence of migration even in a configuration in which the external electrode 5 includes the second electrode layer E2 positioned on both the side surface 3a and the side surface 3b.

### Fourth Example

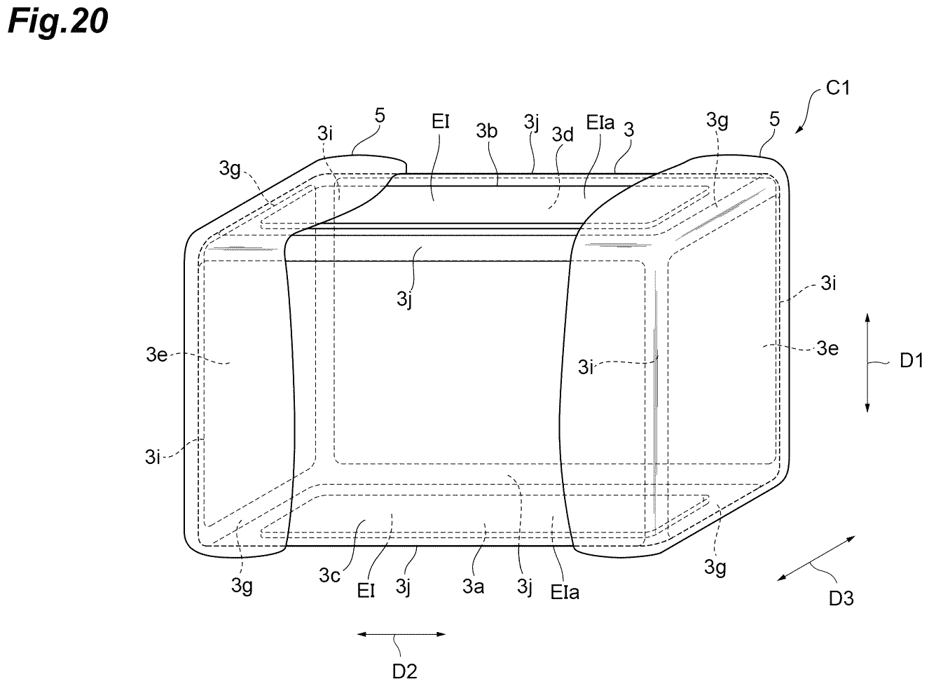

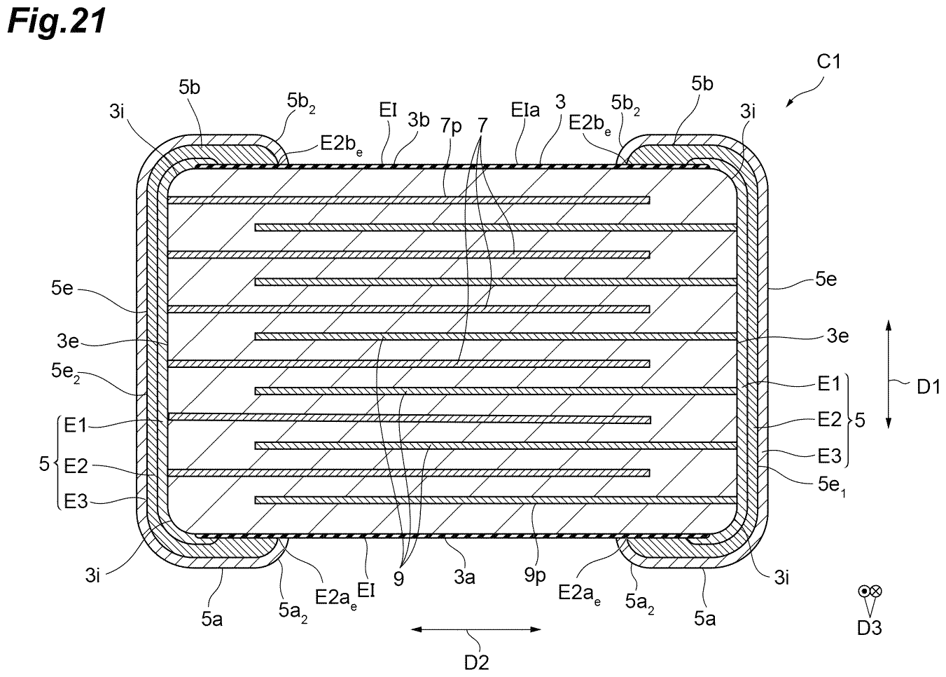

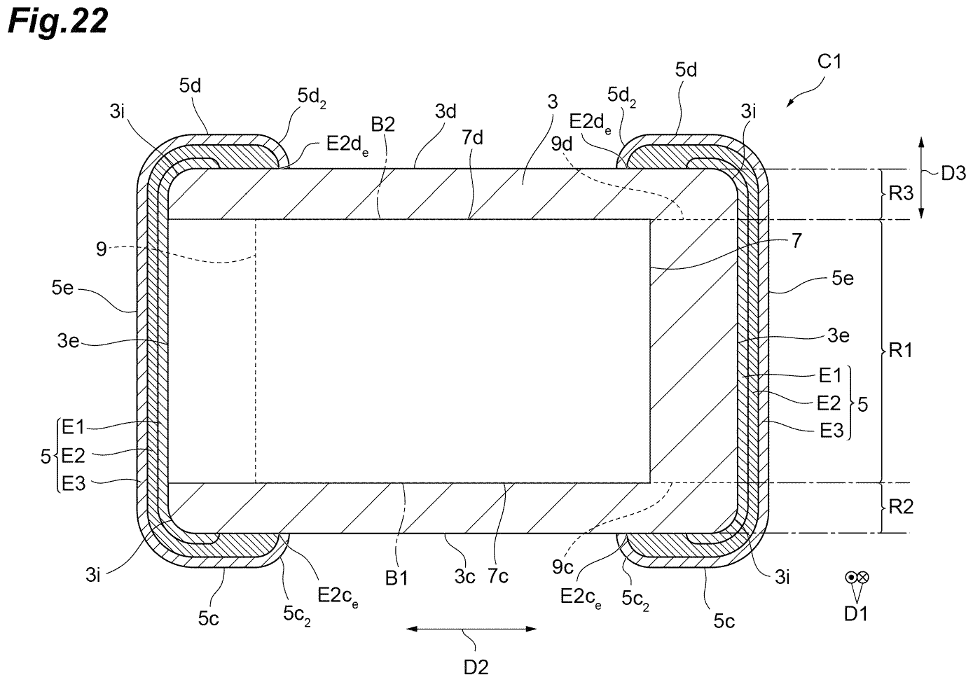

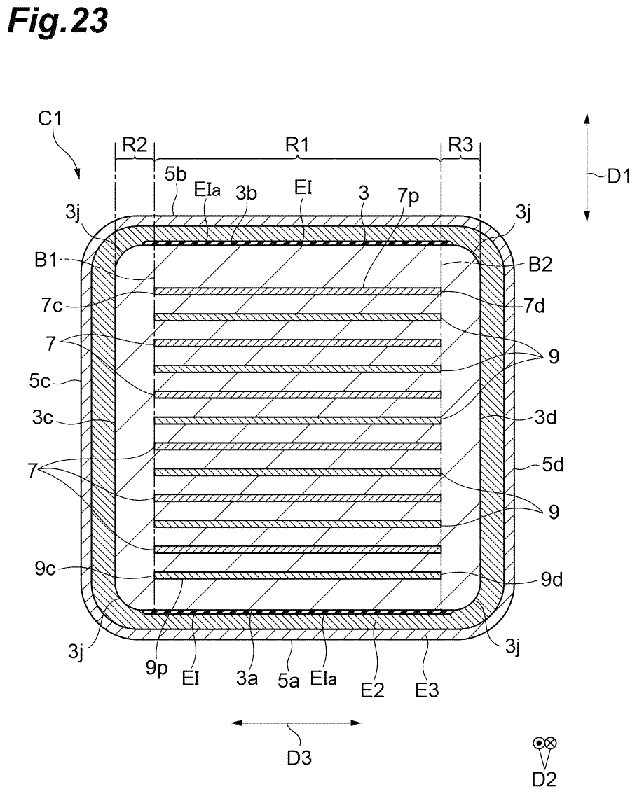

A configuration of a multilayer capacitor C1 according to a fourth example will be described with reference to FIGS. 20 to 23. FIG. 20 is a perspective view of an electronic component according to the fourth example. FIGS. 21, 22, and 23 are views illustrating a cross-sectional configuration of the electronic component according to the fourth example. The multilayer capacitor C1 according to the fourth example is generally similar to or the same as the multilayer capacitor C1 according to the first example. However, the multilayer capacitor C1 according to the fourth example is different from the multilayer capacitor C1 according to the first example in the external electrodes 5 and the electrical insulation film EI. Hereinafter, differences between the above-described first example and the fourth example will be mainly described.

As with the multilayer capacitor C1 according to the first example, the multilayer capacitor C1 according to the fourth example includes an element body 3 of a rectangular parallelepiped shape, a pair of external electrodes 5, a plurality of internal electrodes 7, a plurality of internal electrodes 9, and an electrical insulation film EI. For example, the side surface 3a is arranged to constitute a mounting surface. The side surface 3a includes the mounting surface. For example, when the side surface 3a includes the second side surface, the side surface 3b includes the fourth side surface. For example, when the side surface 3c includes the first side surface, the side surface 3d includes the third side surface. One of the side surfaces 3a, 3b, 3c, and 3d may be arranged to constitute a mounting surface.

Each external electrode 5 includes the plurality of electrode portions 5a, 5b, 5c, 5d, 5e. Each of the electrode portions 5a, 5b, 5c, 5d, and 5e includes the first electrode layer E1, the second electrode layer E2, and the third electrode layer E3. The second electrode layer E2 includes a conductive resin layer.

The second electrode layer E2 of the electrode section 5c is positioned on both the first electrode layer E1 and the side surface 3c. In the electrode section 5c, the second electrode layer E2 is formed on the first electrode layer E1 to cover the first electrode layer E1 of the electrode section 5c, and is also formed on the side surface 3c to cover a part of the side surface 3c. In the electrode section 5c, the second electrode layer E2 is in contact with the above-described part of the side surface 3c and the entirety of the first electrode layer E1. The first electrode layer E1 of the electrode section 5c is entirely covered with the second electrode layer E2. The first electrode layer E1 of the electrode section 5c does not include a region exposed from the second electrode layer E2.

The second electrode layer E2 of the electrode section 5d is positioned on both the first electrode layer E1 and the side surface 3d. In the electrode section 5d, the second electrode layer E2 is formed on the first electrode layer E1 to cover the first electrode layer E1 of the electrode section 5d, and is also formed on the side surface 3d to cover a part of the side surface 3d. In the electrode section 5d, the second electrode layer E2 is in contact with the above-described part of the side surface 3d and the entirety of the first electrode layer E1. The first electrode layer E1 of the electrode section 5d is entirely covered with the second electrode layer E2. The first electrode layer E1 of the electrode section 5d does not include a region exposed from the second electrode layer E2.

The second electrode layer E2 of the electrode portion 5e is positioned on the first electrode layer E1. In the electrode portion 5e, the second electrode layer E2 is formed on the first electrode layer E1 to cover the first electrode layer E1 of the electrode portion 5e. In the electrode portion 5e, the second electrode layer E2 is in contact with the entirety of the first electrode layer E1. The first electrode layer E1 of the electrode portion 5e is entirely covered with the second electrode layer E2. The first electrode layer E1 of the electrode portion 5e does not include a region exposed from the second electrode layer E2.

The plurality of internal electrodes 7 and the plurality of internal electrodes 9 are alternately disposed in the first direction D1. For example, the plurality of internal electrodes 7 and the plurality of internal electrodes 9 may be alternately disposed in the third direction D3.

In the multilayer capacitor C1 according to the fourth example, the element body 3 includes the side surface 3b opposing the side surface 3a. The second electrode layer E2 is positioned on the side surface 3b. The electrical insulation film EI includes the film portion EIa positioned on the region, of the side surface 3b, between the second electrode layer E2.

In the multilayer capacitor C1 according to the fourth example, the region R2 including the side surface 3c has a dielectric constant smaller than a dielectric constant of the region R1. Therefore, the multilayer capacitor C1 according to the fourth example prevents occurrence of a leakage current in the region R2. Even when a metal particle included in the second electrode layer E2 positioned on the side surface 3c ionize, an electron tends not to be supplied to a metal ion. A metal tends not to be deposited on the side surface 3c.

In the multilayer capacitor C1 according to the fourth example, the region R3 including the side surface 3d has a dielectric constant smaller than a dielectric constant of the region R1. Therefore, the multilayer capacitor C1 according to the fourth example prevents occurrence of a leakage current in the region R3. Even when a metal particle included in the second electrode layer E2 positioned on the side surface 3d ionize, an electron tends not to be supplied to a metal ion. A metal tends not to be deposited on the side surface 3d.

In the multilayer capacitor C1 according to the fourth example, the film portion EIa included in the electrical insulation film EI is positioned on the regions, of the side surfaces 3a and 3b, between the second electrode layers E2. Therefore, even when a metal particle included in the second electrode layer E2 positioned on the side surfaces 3a and 3b ionize, the film portions Ela prevent a generated metal ion from reacting with an electron resulting from a leakage current. The electron tends not to be supplied to the metal ion. A metal tends not to be deposited on the side surfaces 3a and 3b.

Consequently, the multilayer capacitor C1 according to the fourth example reduces occurrence of migration even in a configuration in which the external electrode 5 includes the second electrode layer E2 positioned on both the side surface 3a and the side surface 3b.

### Fifth Example

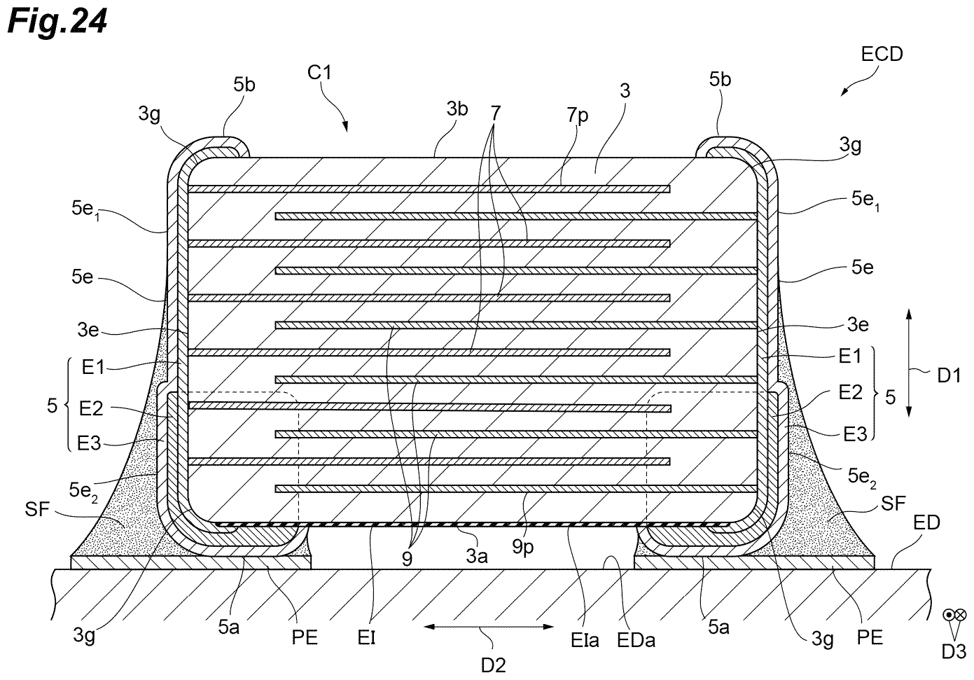

A configuration of an electronic component device ECD according to the fifth example will be described with reference to FIG. 24. FIG. 24 is a view illustrating a cross-sectional configuration of an electronic component device according to the fifth example.

In the fifth example, the electronic component device ECD includes the multilayer capacitor C1 according to the first example and an electronic device ED. The multilayer capacitor C1 according to the first example is mounted on the electronic device ED. For example, the multilayer capacitor C1 according to the first example is solder-mounted on the electronic device ED. The electronic device ED includes, for example, a circuit board or an electronic component. The electronic component device ECD may include the multilayer capacitor C1 according to the modified example of the first example, or any one of the multilayer capacitors C1 according to the second to fourth examples, instead of the multilayer capacitor C1 according to the first example.

The electronic device ED includes the side surface EDa. The electronic device ED includes a pair of pad electrodes PE disposed on the side surface EDa. The pair of pad electrodes PE are electrically connected to the multilayer capacitor C1 according to the first example. Each of the pair of pad electrodes PE is electrically connected to a corresponding external electrode 5 of the plurality of external electrodes 5. The pair of pad electrodes PE are separated from each other in the second direction D2. The multilayer capacitor C1 according to the first example is disposed on the electronic device ED such that the side surface EDa opposes the side surface 3a. Each of the internal electrodes 7, 9 is positioned in a plane substantially parallel to the side surface EDa. The side surface 3a is arranged to constitute a mounting surface. The side surface 3a includes the mounting surface.

In solder-mounting the multilayer capacitor C1 according to the first example, molten solder wets the external electrode 5 (third electrode layer E3). Solidification of the wet solder causes a solder fillet SF to be formed on the external electrode 5. The external electrodes 5 and the pad electrodes PE corresponding to each other are connected to each other through the solder fillet SF.

It is to be understood that not all aspects, advantages and features described herein may necessarily be achieved by, or included in, any one particular example. Indeed, having described and illustrated various examples herein, it should be apparent that other examples may be modified in arrangement and detail.

In the above-described examples and modified examples, the electronic component includes the multilayer capacitor. However, applicable electronic component is not limited to the multilayer capacitor. The applicable electronic component includes, for example, a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

When the outermost internal electrode 7p and the second electrode layer E2 that is not electrically connected to the outermost internal electrode 7p are viewed in the direction perpendicular to the side surface 3c, the outermost internal electrode 7p may not overlap with the second electrode layer E2 that is not electrically connected to the outermost internal electrode 7p. When the outermost internal electrode 9p and the second electrode layer E2 that is not electrically connected to the outermost internal electrode 9p are viewed in the direction perpendicular to the side surface 3c, the outermost internal electrode 9p may not overlap with the second electrode layer E2 that is not electrically connected to the outermost internal electrode 9p.

What is claimed is:

1. An electronic component, comprising:
an element body of a rectangular parallelepiped shape including a pair of end surfaces opposing each other, and a first side surface and a second side surface adjacent to each other and to the pair of end surfaces;
a plurality of external electrodes disposed on both ends of the element body in a direction in which the pair of end surfaces oppose each other, and each including a conductive resin layer positioned on both the first side surface and the second side surface;
a plurality of internal electrodes disposed in the element body, and each electrically connected to a corresponding external electrode of the plurality of external electrodes; and
an electrical insulation film having disposed on the element body,
wherein the element body includes:
a first region positioned away from the first side surface and in which the plurality of internal electrodes are disposed, and
a second region including the first side surface and having a dielectric constant smaller than a dielectric constant of the first region, and
the electrical insulation film includes a film portion positioned on a region, of the second side surface, between the conductive resin layers.

2. The electronic component according to claim 1, wherein
the element body further includes a third side surface opposing the first side surface, and further includes a third region including the third side surface and having a dielectric constant smaller than the dielectric constant of the first region, and
the conductive resin layer is further positioned on the third side surface.

3. The electronic component according to claim 2, wherein
the plurality of internal electrodes oppose each other in a direction orthogonal to the direction in which the pair of end surfaces oppose each other and a direction in which the first side surface and the third side surface oppose each other.

4. The electronic component according to claim 3, wherein
the plurality of internal electrodes includes an outermost internal electrode adjacent to the second side surface, and
when the outermost internal electrode and the conductive resin layer that is not electrically connected to the outermost internal electrode are viewed in a direction orthogonal to the first side surface, the outermost internal electrode overlaps with the conductive resin layer that is not electrically connected to the outermost internal electrode.

5. The electronic component according to claim 2, wherein
the conductive resin layer continuously covers a part of the first side surface, a part of the second side surface, a part of the third side surface, and a part of a corresponding end surface of the pair of end surfaces.

6. The electronic component according to claim 1, wherein
the element body further includes a fourth side surface opposing the second side surface,
the conductive resin layer is further positioned on the fourth side surface, and
the electrical insulation film further includes a film portion positioned on a region, of the fourth side surface, between the conductive resin layers.

7. The electronic component according to claim 1, wherein:
the element body further includes a third side surface opposing the first side surface and a fourth side surface opposing the second side surface, and further includes a third region including the third side surface and having a dielectric constant smaller than the dielectric constant of the first region,
the conductive resin layer is further positioned on the fourth side surface, and
the electrical insulation film further includes a film portion positioned on a region, of the fourth side surface, between the conductive resin layers.

8. The electronic component according to claim 7, wherein:
the plurality of internal electrodes oppose each other in a direction in which the second side surface and the fourth side surface oppose each other.

9. The electronic component according to claim 8, wherein:
the plurality of internal electrodes include a first outermost internal electrode adjacent to the second side surface and a second outermost internal electrode adjacent to the fourth side surface,
when the first outermost internal electrode and the conductive resin layer that is not electrically connected to the first outermost internal electrode are viewed in a direction orthogonal to the second side surface, the first outermost internal electrode overlaps with the conductive resin layer that is not electrically connected to the first outermost internal electrode, and
when the second outermost internal electrode and the conductive resin layer that is not electrically connected to the second outermost internal electrode are viewed in a direction orthogonal to the fourth side surface, the second outermost internal electrode overlaps with the conductive resin layer that is not electrically connected to the second outermost internal electrode.

10. The electronic component according to claim 7, wherein
the conductive resin layer continuously covers a part of the first side surface, a part of the second side surface, a part of the fourth side surface, and a part of a corresponding end surface of the pair of end surfaces.

11. The electronic component according to claim 1, wherein
each of the plurality of internal electrodes is positioned in the first region away from an end, of the first region, opposing the first side surface.

12. The electronic component according to claim 2, wherein
each of the plurality of internal electrodes is positioned in the first region away from an end, of the first region, opposing the third side surface.

13. The electronic component according to claim 7, wherein
each of the plurality of internal electrodes is positioned in the first region away from an end, of the first region, opposing the third side surface.

14. The electronic component according to claim 1, wherein
the conductive resin layer includes a plurality of silver particles.

15. An electronic component comprising:
an element body of a rectangular parallelepiped shape including a pair of end surfaces opposing each other, and a first side surface and a second side surface adjacent to each other and to the pair of end surfaces;
a plurality of external electrodes disposed on both ends of the element body in a direction in which the pair of end surfaces oppose each other, and each including a conductive resin layer positioned on both the first side surface and the second side surface;
a plurality of internal electrodes disposed in the element body, and each electrically connected to a corresponding external electrode of the plurality of external electrodes; and
an electrical insulation film disposed on the element body,
wherein the first side surface has a surface electrical resistivity larger than a surface electrical resistivity of the second side surface, and
the electrical insulation film includes a film portion positioned on a region, of the second side surface, between the conductive resin layers.
